(19) United States
(12) Patent Application Publication
(10) Pub. No.: US 2026/0153707 A1
(43) Pub. Date: Jun. 4, 2026

(54) OPTICAL IMAGING SYSTEM

(71) Applicant: SAMSUNG ELECTRO-MECHANICS CO., LTD., Suwon-si (KR)

(72) Inventors: Kum Ho KIM, Suwon-si (KR); Dong Hyuk JANG, Suwon-si (KR); Su Hyeok LEE, Suwon-si (KR); Phil Ho JUNG, Suwon-si (KR); Min Hyuk IM, Suwon-si (KR); Dong Shin YANG, Suwon-si (KR)

(73) Assignee: SAMSUNG ELECTRO-MECHANICS CO., LTD., Suwon-si (KR)

(21) Appl. No.: 19/296,144

(22) Filed: Aug. 11, 2025

(30) Foreign Application Priority Data
Nov. 29, 2024 (KR) 10-2024-0175230
Apr. 11, 2025 (KR) 10-2025-0047539

(51) Int. Cl. G02B 13/00; G02B 9/64

(52) U.S. Cl. CPC G02B 13/0045; G02B 9/64

(57) ABSTRACT

An optical imaging system includes a first lens having positive refractive power, a second lens having refractive power, a third lens having positive refractive power, a fourth lens having negative refractive power, a fifth lens having refractive power, a sixth lens having a convex object-side surface, and a seventh lens having negative refractive power, wherein the first to seventh lenses are disposed in order from an object side, and wherein the following conditional expression is satisfied: 2.7<SD1/SD5<3.3, where SD1 is an effective radius of an object-side surface of the first lens, and SD5 is an effective radius of an object-side surface of the third lens.

### CROSS-REFERENCE TO RELATED APPLICATIONS

This application claims the benefit under 35 USC 119(a) of Korean Patent Application No. 10-2024-0175230 filed on Nov. 29, 2024, and Korean Patent Application No. 10-2025-0047539 filed on Apr. 11, 2025, in the Korean Intellectual Property Office, the entire disclosures of which are incorporated herein by reference for all purposes.

### BACKGROUND

### 1. Field

The following description relates to an optical imaging system, and more particularly, to an optical imaging system applied to an ultra-wide-angle camera.

### 2. Description of the Background

A demand for higher performance cameras for mobile devices may be increasing.

Accordingly, high-pixel (e.g., 13 million to 200 million pixel) sensors are being developed, and the number of lenses provided in cameras is also increasing to implement high-resolution and bright optical systems in line with the performance of sensors.

However, since mobile devices have thickness constraints, there may be a problem in that when high-performance optical systems are applied, a portion of the camera protrudes outside the portable electronic device.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens having positive refractive power, a second lens having refractive power, a third lens having positive refractive power, a fourth lens having negative refractive power, a fifth lens having refractive power, a sixth lens having a convex object-side surface, and a seventh lens having negative refractive power, wherein the first to seventh lenses are disposed in order from an object side, and wherein the following conditional expression is satisfied: 2.7<SD1/SD5<3.3, where SD1 is an effective radius of an object-side surface of the first lens, and SD5 is an effective radius of an object-side surface of the third lens.

The first lens may have a concave object-side surface.

The third lens may have a convex object-side surface and a convex image-side surface.

Both the second lens and the fifth lens may have positive refractive power or both may have negative refractive power.

The sixth lens may have negative refractive power.

The sixth lens may have a concave image-side surface.

The second lens and the sixth lens may each have negative refractive power.

The sixth lens may have positive refractive power and a convex image-side surface.

The following conditional expressions may be satisfied: 10<V1−V2<50, and −10<V1−V5<30, where V1 is an Abbe number of the first lens, V2 is an Abbe number of the second lens, and V5 is an Abbe number of the fifth lens.

The following conditional expression may be satisfied: 25<FOV/f<30 (unit: degree(°)/mm), where FOV is a field of view of the optical imaging system, and f is a total focal length of the optical imaging system.

The following conditional expression may be satisfied: 1.40<{TTL/(2×IMG HT)}×Fno<1.60, where TTL is a distance on an optical axis from an object-side surface of the first lens to an imaging plane, IMG HT is half a diagonal length of the image plane, and Fno (F-number) is a value representing brightness of the optical imaging system.

The following conditional expression may be satisfied: 0.27<SD6/SD14<0.35, where SD6 is an effective radius of an image-side surface of the third lens, and SD14 is an effective radius of an image-side surface of the seventh lens.

In another general aspect, an optical imaging system includes a first lens having positive refractive power, a second lens having refractive power, a third lens having a convex object-side surface and a convex image-side surface, a fourth lens having negative refractive power, a fifth lens having refractive power, a sixth lens having a convex object-side surface, and a seventh lens having negative refractive power, wherein the first to seventh lenses are disposed in order from an object side.

The following conditional expressions may be satisfied: 10<V1-V2<50, and −10<V1-V7<10, where V1 is an Abbe number of the first lens, V2 is an Abbe number of the second lens, and V7 is an Abbe number of the seventh lens.

The following conditional expression may be satisfied: 0.95<2×f×tan(FOV/2)/(2×IMG HT)<1.05, where f is a total focal length of the optical imaging system, FOV is a field of view of the optical imaging system, and IMG HT is half a diagonal length of an imaging plane.

The following conditional expression may be satisfied: 2.7<SD1/SD5<3.3, where SD1 is an effective radius of an object-side surface of the first lens, and SD5 is an effective radius of an object-side surface of the third lens.

Other features and aspects will be apparent from the following detailed description, the drawings, and the claims.

### BRIEF DESCRIPTION OF DRAWINGS

FIG. 1A is a configuration diagram of an optical imaging system according to a first embodiment of the present disclosure.

FIG. 1B is a graph illustrating aberration characteristics of the optical imaging system according to FIG. 1A.

FIG. 2A is a configuration diagram of an optical imaging system according to a second embodiment of the present disclosure.

FIG. 2B is a graph illustrating aberration characteristics of the optical imaging system according to FIG. 2A.

FIG. 3A is a configuration diagram of an optical imaging system according to a third embodiment of the present disclosure.

FIG. 3B is a graph illustrating aberration characteristics of the optical imaging system according to FIG. 3A.

FIG. 4A is a configuration diagram of an optical imaging system according to a fourth embodiment of the present disclosure.

FIG. 4B is a graph illustrating aberration characteristics of the optical imaging system according to FIG. 4A.

FIG. 5A is a configuration diagram of an optical imaging system according to a fifth embodiment of the present disclosure.

FIG. 5B is a graph illustrating aberration characteristics of the optical imaging system according to FIG. 5A.

FIG. 6A is a configuration diagram of an optical imaging system according to a sixth embodiment of the present disclosure.

FIG. 6B is a graph illustrating aberration characteristics of the optical imaging system according to FIG. 6A.

FIG. 7A is a configuration diagram of an optical imaging system according to a seventh embodiment of the present disclosure.

FIG. 7B is a graph illustrating aberration characteristics of the optical imaging system according to FIG. 7A.

FIG. 8A is a configuration diagram of an optical imaging system according to an eighth embodiment of the present disclosure.

FIG. 8B is a graph illustrating aberration characteristics of the optical imaging system according to FIG. 8A.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

In the attached configuration diagrams, a thickness, a size, and a shape of a lens may be somewhat exaggerated for explanation purposes, and in particular, a spherical or aspherical shape illustrated in the lens configuration diagram may be illustrative, but may not be limited thereto.

One or more embodiments of the present disclosure may provide an ultra-wide-angle slim optical system capable of implementing high resolution and a low F value.

An optical imaging system according to embodiments of the present disclosure may be mounted on a portable electronic device. For example, the optical imaging system may configure a portion of a camera module mounted on the portable electronic device, and the portable electronic device may be a smart phone, a tablet PC, or the like.

In the present specification, a first lens (or foremost lens) refers to a lens closest to an object side, and the last lens (or rearmost lens), for example, a seventh lens, refers to a lens closest to an imaging plane of an image sensor. In this case, the imaging plane refers to a virtual plane on which focus is formed by the optical imaging system or one surface of the image sensor where light is received.

In addition, in the description of each lens, a first surface refers to a surface close to an object side (or an object-side surface), and a second surface refers to a surface close to an image side (or an image-side surface).

Additionally, in the description of a shape of each lens, a configuration in which one surface is convex indicates that a paraxial region (a very narrow region near and including the optical axis) of the one surface is convex, and a configuration in which one surface is concave indicates that a paraxial region of the one surface is concave.

For example, a statement that an object-side surface of a lens is convex means that at least a paraxial region of the object-side surface of the lens is convex, and a statement that an image-side surface of the lens is concave means that at least a paraxial region of the image-side surface of the lens is concave. Therefore, even though the object-side surface of the lens may be described as being convex, the entire object-side surface of the lens may not be convex, and a peripheral region of the object-side surface of the lens may be concave. Also, even though the image-side surface of the lens may be described as being concave, the entire image-side surface of the lens may not be concave, and a peripheral region of the image-side surface of the lens may be convex.

An effective aperture radius of a lens surface is a radius of a portion of the lens surface through which light actually passes, and is not necessarily a radius of an outer edge of the lens surface. An object-side surface of a lens and an image-side surface of the lens may have different effective aperture radiuses.

Stated another way, an effective aperture radius of a lens surface is a distance in a direction perpendicular to an optical axis of the lens surface between the optical axis of the lens surface and a marginal ray of light passing through the lens surface.

In addition, in the present specification, numerical values of a radius of curvature, a thickness, a distance, a focal length, or the like of the lenses, are all in mm, and a unit of field of view is degrees (°).

An optical imaging system according to embodiments of the present disclosure may include a plurality of lenses. For example, the optical imaging system may include a first lens, a second lens, a third lens, a fourth lens, a fifth lens, a sixth lens, and a seventh lens, and the first to seventh lenses may be disposed in order from an object side.

The optical imaging system according to embodiments of the present disclosure may include lenses formed of a plastic material. For example, the first to seventh lenses may all be formed of a plastic material.

The optical imaging optical system according to embodiments of the present disclosure may include a lens having at least one aspherical surface. For example, at least one of the first to seventh lenses may have at least one surface of the first surface and the second surface as an aspheric surface. The aspheric surface of each lens may be expressed by the following Equation 1.

$$Z = \frac{c {Y}^{2}}{1 + \sqrt{1 - ( 1 + k ) {c}^{2} {Y}^{2}}} + A {Y}^{4} + B {Y}^{6} + C {Y}^{8} + D {Y}^{10} + E {Y}^{12} + F {Y}^{14} + G {Y}^{16} + H {Y}^{18} + {JY}^{20} + {LY}^{22} + M {Y}^{24} + N {Y}^{26} + {OY}^{28} + P {Y}^{30} … \qquad [ Equation 1 ]$$

In Equation 1, c is a reciprocal of a radius of curvature of a lens, K is a conic constant, Y refers to a distance from certain point on an aspherical surface of the lens to an optical axis. Also, constants A to H, J, and L to P are aspherical constants corresponding from 4th to 30th in order, and Z (SAG) is a distance in an optical axis direction between certain points on the aspheric surface of the lens and a vertex of the corresponding aspheric surface.

The optical imaging system according to embodiments of the present disclosure may further include an image sensor converting light reflected from a subject into an electrical signal.

In addition, the optical imaging system may further include an infrared blocking filter (hereinafter, “filter”) for blocking infrared rays incident on the image sensor. The filter may be disposed between the seventh lens and the image sensor.

Additionally, the optical imaging system may further include a stop for controlling an amount of light. For example, the stop may be disposed between the second lens and the third lens.

The optical imaging system according to embodiments of the present disclosure may be an ultra-wide-angle optical system and may have a field of view of 100 degrees or more.

An optical imaging system according to embodiments of the present disclosure may satisfy one or more of the following conditional expressions.

$$0.70 < TTL / ( 2 \times IMG HT ) < 0.76 \qquad [ Conditional expression 1 ]$$

$$1.4 < \{ TTL / ( 2 \times IMG HT ) \} \times F n o < 1.6 \qquad [ Conditional expression 2 ]$$

$$0.95 < 2 \times f \times tan ( FOV / 2 ) / ( 2 \times IMG HT ) < 1.05 \qquad [ Conditional expression 3 ]$$

$$0.65 < 10 \; 0 \times \{ TTL / ( 2 \times IMG HT ) \} / FOV < 0.75 ( unit : {deg}^{- 1} ) \qquad [ Conditional expression 4 ]$$

$$2.7 < SD 1 / SD 5 < 3. 3 \qquad [ Conditional expression 5 ]$$

$$0.27 < SD 6 / SD 14 < 0.35 \qquad [ Conditional expression 6 ]$$

$$25 < FOV / f < 30 ( unit : degree ( ° ) / mm ) \qquad [ Conditional expression 7 ]$$

$$10 < V 1 - V 2 < 50 \qquad [ Conditional expression 8 ]$$

$$- 10 < V 1 - V 5 < 30 \qquad [ Conditional expression 9 ]$$

$$- 10 < V 1 - V 7 < 10 \qquad [ Conditional expression 10 ]$$

$$1.9 < Fno < 2.1 \qquad [ Conditional expression 11 ]$$

In [Conditional Expression 1], TTL is a distance on an optical axis from an object-side surface of the first lens to an imaging plane, and IMG HT is half a diagonal length of the imaging plane (i.e., 2×IMG HT is a diagonal length of imaging plane). [Conditional Expression 1] is a value (slim factor) representing a total length of the optical imaging system compared to a size of the image sensor, which is an index of miniaturization of the optical imaging system, and when [Conditional Expression 1] is satisfied, it may correspond to a slim optical system.

In [Conditional Expression 2], Fno (F-number) is a value representing brightness of the optical imaging system. [Conditional expression 2] is a ratio of the slim factor and the brightness of the optical imaging system, and when [Conditional expression 2] is satisfied, a lower value may correspond to a brighter and slimmer optical system.

In [Conditional Expression 3], f is a total focal length of the optical imaging system, and FOV is a field of view of the optical imaging system. [Conditional Expression 3] is a ratio of a total focal length, angle of view, and diagonal length of the imaging plane of the optical imaging system, and when [Conditional Expression 3] is satisfied, the camera distortion phenomenon may be minimized.

[Conditional expression 4] is a ratio of a slim factor and a field of view of the optical imaging system, and when [Conditional expression 4] is satisfied, it may correspond to a slim ultra-wide-angle optical system.

In [Conditional Expression 5] and [Conditional Expression 6], SD1 is an effective radius of an object-side surface of the first lens, SD5 is an effective radius of an object-side surface of the third lens, SD6 is an effective radius of an image-side surface of the third lens, and SD14 is an effective radius of an image-side surface of the seventh lens. [Conditional expression 5] and [Conditional expression 6] are ratios of the third lens and a first lens (the first lens), and the third lens and the last lens (the seventh lens), respectively, and when the ranges of [Conditional expression 5] and [Conditional expression 6] are satisfied, the optical imaging system may implement high pixels while having a field of view of 100 degrees or more.

[Conditional expression 7] is a ratio of a total focal length and angle of view of the optical imaging system, and when the range of [Conditional expression 7] is satisfied, it may correspond to an ultra-wide-angle optical system.

In [Conditional Expressions 8] to [Conditional Expressions 10], V1 is an Abbe number of the first lens, V2 is an Abbe number of the second lens, V5 is an Abbe number of the fifth lens, and V7 is an Abbe number of the seventh lens. When [Conditional Expression 8] to [Conditional Expression 10] are satisfied, chromatic aberration may be minimized.

[Conditional expression 11] refers to brightness performance of the optical imaging system according to embodiments of the present disclosure.

### 1st Embodiment

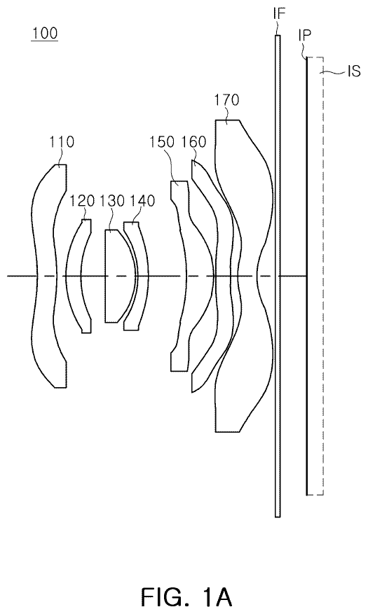

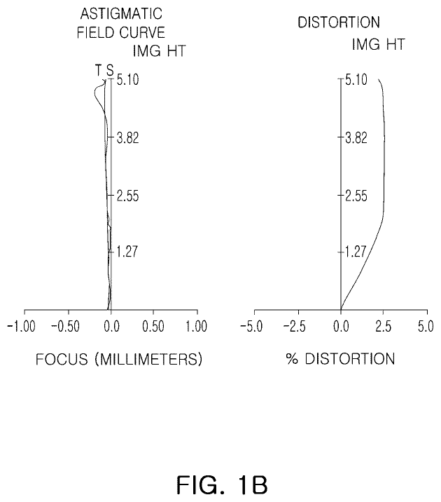

FIG. 1A is a configuration diagram of an optical imaging system according to a first embodiment of the present disclosure, and FIG. 1B is a graph illustrating aberration characteristics of the optical imaging system according to FIG. 1A.

An optical imaging system 100 according to the first embodiment of the present disclosure may include a first lens 110, a second lens 120, a third lens 130, a fourth lens 140, a fifth lens 150, a sixth lens 160, and a seventh lens 170 disposed in order from an object side. Additionally, an image sensor IS having a filter IF and an imaging plane IP may be sequentially disposed on an image side of the seventh lens 170. A stop (not shown) for controlling the amount of light may be disposed between the second lens 120 and the third lens 130.

Physical and optical characteristics of optical elements configuring the optical imaging system 100 according to the first embodiment of the present disclosure are as illustrated in Table 1 below.

TABLE 1

| Surface | | Radius of | Thickness/ | Refractive | | Effective radius |
|---|---|---|---|---|---|---|
| No. | Component | Curvature | Distance | Index | Abbe No. | (Clear Aperture) |
| S1 | 1st Lens | −3.120 | 0.539 | 1.546 | 56.00 | 2.879 |
| S2 | | −3.057 | 0.220 | | | 2.328 |
| S3 | 2nd Lens | 3.206 | 0.439 | 1.619 | 25.90 | 1.477 |
| S4 | | 3.536 | 0.468 | | | 1.229 |
| S5 | STOP | Infinity | 0.177 | | | 1.014 |
| S6 | 3rd Lens | 27.304 | 0.828 | 1.546 | 56.00 | 0.938 |
| S7 | | −2.316 | 0.046 | | | 1.195 |
| S8 | 4th Lens | −3.402 | 0.280 | 1.688 | 18.20 | 1.254 |
| S9 | | −6.995 | 1.048 | | | 1.416 |
| S10 | 5th Lens | −4.674 | 0.773 | 1.546 | 56.00 | 2.108 |
| S11 | | −1.658 | 0.030 | | | 2.479 |
| S12 | 6th Lens | 12.570 | 0.400 | 1.677 | 19.20 | 2.683 |
| S13 | | 5.765 | 0.199 | | | 3.025 |
| S14 | 7th Lens | 1.533 | 0.522 | 1.546 | 56.00 | 3.640 |
| S15 | | 0.925 | 0.530 | | | 4.080 |
| S16 | Filter | Infinity | 0.110 | 1.518 | 64.17 | |
| S17 | | Infinity | 0.750 | | | |
| S18 | Imaging | Infinity | | | | |
| | Plane | | | | | |

In the first embodiment of the present disclosure, the first lens 110 may have positive refractive power, a first surface of the first lens 110 may have a concave shape, and a second surface of the first lens 110 may have a convex shape. The second lens 120 may have positive refractive power, a first surface of the second lens 120 may have a convex shape, and a second surface of the second lens 120 may have a concave shape. The third lens 130 may have positive refractive power, and both a first surface and a second surface of the third lens 130 may have a convex shape. The fourth lens 140 may have negative refractive power, a first surface of the fourth lens 140 may have a concave shape, and a second surface of the fourth lens 140 may have a convex shape. The fifth lens 150 may have positive refractive power, a first surface of the fifth lens 150 may have a concave shape, and a second surface of the fifth lens 150 may have a convex shape. The sixth lens 160 may have negative refractive power, a first surface of the sixth lens 160 may have a convex shape, and a second surface of the sixth lens 160 may have a concave shape. The seventh lens 170 may have negative refractive power, a first surface of the seventh lens 170 may have a convex shape, and a second surface of the seventh lens 170 may have a concave shape.

The optical imaging system 100 according to the first embodiment of the present disclosure may include three or more high refractive lenses. A high refractive lens may refer to a lens having a refractive index of 1.6 or higher, and the second lens 120, the fourth lens 140, and the sixth lens 160 may correspond to high refractive lenses, and a refractive index of the fourth lens 140 may be the maximum.

Aspherical data of individual lenses configuring optical imaging system 100 according to the first embodiment of the present disclosure are as illustrated in Table 2 below. According to the first embodiment, both the first and second surfaces of the first lens 110 to the seventh lens 170 may be aspherical.

TABLE 2

| | S1 | S2 | S3 | S4 | S6 | S7 | S8 |
|---|---|---|---|---|---|---|---|
| Conic Constant K | −17.391 | −30.084 | −3.775 | −32.258 | −59.267 | 0.060 | 5.221 |
| 4th Coefficient A | 5.392E−03 | 1.035E−02 | 8.248E−02 | 5.891E−02 | −6.281E−02 | −2.011E−02 | −4.882E−02 |
| 6th Coefficient B | 1.764E−02 | 3.024E−02 | −1.886E−01 | 4.390E−01 | 1.003E+00 | −1.692E−01 | −1.026E−01 |
| 8th Coefficient C | −2.192E−02 | −5.087E−02 | 6.676E−01 | −4.236E+00 | −9.240E+00 | 2.700E+00 | 2.021E+00 |
| 10th Coefficient D | 1.828E−02 | 6.120E−02 | −1.964E+00 | 2.228E+01 | 5.288E+01 | −2.119E+01 | −1.546E+01 |
| 12th Coefficient E | −1.070E−02 | −5.196E−02 | 4.379E+00 | −7.564E+01 | −1.971E+02 | 1.003E+02 | 6.869E+01 |
| 14th Coefficient F | 4.492E−03 | 3.175E−02 | −7.011E+00 | 1.765E+02 | 4.858E+02 | −3.142E+02 | −1.994E+02 |
| 16th Coefficient G | −1.372E−03 | −1.422E−02 | 7.998E+00 | −2.914E+02 | −7.825E+02 | 6.801E+02 | 3.972E+02 |
| 18th Coefficient H | 3.072E−04 | 4.710E−03 | −6.498E+00 | 3.451E+02 | 7.673E+02 | −1.039E+03 | −5.565E+02 |
| 20th Coefficient J | −5.028E−05 | −1.155E−03 | 3.734E+00 | −2.934E+02 | −3.349E+02 | 1.129E+03 | 5.525E+02 |
| 22nd Coefficient L | 5.933E−06 | 2.072E−04 | −1.490E+00 | 1.771E+02 | −1.392E+02 | −8.657E+02 | −3.861E+02 |
| 24th Coefficient M | −4.904E−07 | −2.652E−05 | 3.975E−01 | −7.390E+01 | 2.665E+02 | 4.579E+02 | 1.855E+02 |
| 26th Coefficient N | 2.687E−08 | 2.297E−06 | −6.603E−02 | 2.019E+01 | −1.358E+02 | −1.589E+02 | −5.822E+01 |
| 28th Coefficient O | −8.745E−10 | −1.208E−07 | 5.913E−03 | −3.241E+00 | 2.519E+01 | 3.253E+01 | 1.074E+01 |
| 30th Coefficient P | 1.275E−11 | 2.910E−09 | −1.967E−04 | 2.307E−01 | 0.000E+00 | −2.980E+00 | −8.826E−01 |

| | S9 | S10 | S11 | S12 | S13 | S14 | S15 |
|---|---|---|---|---|---|---|---|
| Conic Constant K | −87.018 | 1.533 | −1.494 | 8.528 | −1.284 | −1.593 | −3.180 |
| 4th Coefficient A | −7.319E−02 | −8.034E−02 | 2.947E−02 | 2.234E−01 | 1.783E−01 | −3.135E−01 | −1.794E−01 |
| 6th Coefficient B | 3.415E−02 | 3.885E−01 | −5.978E−02 | −4.277E−01 | −3.813E−01 | 1.042E−01 | 1.239E−01 |
| 8th Coefficient C | −9.862E−02 | −9.811E−01 | −2.449E−02 | 3.827E−01 | 3.491E−01 | 1.754E−02 | −5.818E−02 |
| 10th Coefficient D | 4.563E−01 | 1.640E+00 | 1.621E−01 | −2.088E−01 | −2.015E−01 | −3.589E−02 | 1.946E−02 |
| 12th Coefficient E | −1.610E+00 | −1.905E+00 | −2.081E−01 | 6.793E−02 | 7.907E−02 | 1.904E−02 | −4.738E−03 |
| 14th Coefficient F | 3.846E+00 | 1.585E+00 | 1.491E−01 | −9.326E−03 | −2.173E−02 | −6.015E−03 | 8.520E−04 |
| 16th Coefficient G | −6.405E+00 | −9.585E−01 | −6.864E−02 | −2.280E−03 | 4.194E−03 | 1.281E−03 | −1.141E−04 |
| 18th Coefficient H | 7.597E+00 | 4.239E−01 | 2.138E−02 | 1.561E−03 | −5.518E−04 | −1.917E−04 | 1.141E−05 |
| 20th Coefficient J | −6.444E+00 | −1.367E−01 | −4.597E−03 | −4.188E−04 | 4.462E−05 | 2.043E−05 | −8.467E−07 |
| 22nd Coefficient L | 3.869E+00 | 3.173E−02 | 6.835E−04 | 6.835E−05 | −1.286E−06 | −1.544E−06 | 4.591E−08 |
| 24th Coefficient M | −1.600E+00 | −5.157E−03 | −6.888E−05 | −7.230E−06 | −1.433E−07 | 8.090E−08 | −1.766E−09 |
| 26th Coefficient N | 4.323E−01 | 5.560E−04 | 4.478E−06 | 4.860E−07 | 1.853E−08 | −2.797E−09 | 4.559E−11 |
| 28th Coefficient O | −6.848E−02 | −3.567E−05 | −1.686E−07 | −1.893E−08 | −8.827E−10 | 5.742E−11 | −7.083E−13 |
| 30th Coefficient P | 4.808E−03 | 1.029E−06 | 2.772E−09 | 3.257E−10 | 1.627E−11 | −5.303E−13 | 5.006E−15 |

### 2nd Embodiment

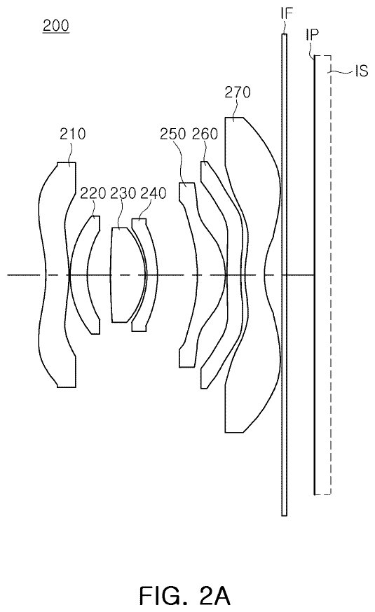

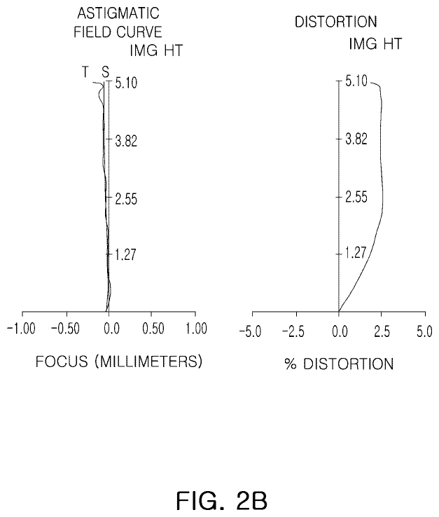

FIG. 2A is a configuration diagram of an optical imaging system according to a second embodiment of the present disclosure, and FIG. 2B is a graph illustrating aberration characteristics of the optical imaging system according to FIG. 2A.

An optical imaging system 200 according to the second embodiment of the present disclosure may include a first lens 210, a second lens 220, a third lens 230, a fourth lens 240, a fifth lens 250, a sixth lens 260, and a seventh lens 270 disposed in order from an object side. Additionally, an image sensor IS having a filter IF and an imaging plane IP may be sequentially disposed on an image side of the seventh lens 170. A stop (not shown) for controlling the amount of light may be disposed between the second lens 220 and the third lens 230.

Physical and optical characteristics of optical elements configuring the optical imaging system 200 according to the second embodiment of the present disclosure are as illustrated in Table 3 below.

TABLE 3

| Surface | | Radius of | Thickness/ | Refractive | | Effective radius |
|---|---|---|---|---|---|---|
| No. | Component | Curvature | Distance | Index | Abbe No. | (Clear Aperture) |
| S1 | 1st Lens | −3.271 | 0.647 | 1.546 | 56.00 | 2.880 |
| S2 | | −2.964 | 0.030 | | | 2.200 |
| S3 | 2nd Lens | 2.772 | 0.481 | 1.619 | 25.90 | 1.489 |
| S4 | | 2.661 | 0.635 | | | 1.205 |
| S5 | STOP | Infinity | 0.007 | | | 0.900 |
| S6 | 3rd Lens | 20.271 | 0.930 | 1.546 | 56.00 | 1.219 |
| S7 | | −2.305 | 0.030 | | | 1.265 |
| S8 | 4th Lens | −3.120 | 0.280 | 1.688 | 18.20 | 1.421 |
| S9 | | −5.236 | 1.111 | | | 2.023 |
| S10 | 5th Lens | −3.620 | 0.753 | 1.546 | 56.00 | 2.371 |
| S11 | | −1.457 | 0.030 | | | 2.552 |
| S12 | 6th Lens | 43.922 | 0.397 | 1.677 | 19.20 | 2.919 |
| S13 | | 8.390 | 0.100 | | | 3.630 |
| S14 | 7th Lens | 1.528 | 0.496 | 1.546 | 56.00 | 4.090 |
| S15 | | 0.884 | 0.515 | | | 2.880 |
| S16 | Filter | Infinity | 0.110 | 1.518 | 64.17 | |
| S17 | | Infinity | 0.793 | | | |
| S18 | Imaging | Infinity | | | | |
| | Plane | | | | | |

In the second embodiment of the present disclosure, the first lens 210 may have positive refractive power, a first surface of the first lens 210 may have a concave shape, and a second surface of the first lens 210 may have a convex shape. The second lens 220 may have positive refractive power, a first surface of the second lens 220 may have a convex shape, and a second surface of the second lens 220 may have a concave shape. The third lens 230 may have positive refractive power, and both a first surface and a second surface of the third lens 230 may have a convex shape. The fourth lens 240 may have negative refractive power, a first surface of the fourth lens 240 may have a concave shape, and a second surface of the fourth lens 240 may have a convex shape. The fifth lens 250 may have positive refractive power, a first surface of the fifth lens 250 may have a concave shape, and a second surface of the fifth lens 250 may have a convex shape. The sixth lens 260 may have negative refractive power, a first surface of the sixth lens 260 may have a convex shape, and a second surface of the sixth lens 260 may have a concave shape. The seventh lens 270 may have negative refractive power, a first surface of the seventh lens 270 may have a convex shape, and a second surface of the seventh lens 270 may have a concave shape.

The optical imaging system 200 according to the second embodiment of the present disclosure may include three or more high refractive lenses. A high refractive lens may refer to a lens having a refractive index of 1.6 or higher, and the second lens 220, the fourth lens 240, and the sixth lens 260 may correspond to high refractive lenses, and a refractive index of the fourth lens 240 may be the maximum.

Aspherical data of individual lenses configuring optical imaging system 200 according to the second embodiment of the present disclosure are as illustrated in Table 4 below. According to the second embodiment, both the first and second surfaces of the first lens 210 to the seventh lens 270 may be aspherical.

TABLE 4

| | S1 | S2 | S3 | S4 | S6 | S7 | S8 |
|---|---|---|---|---|---|---|---|
| Conic Constant K | −15.997 | −35.487 | −1.947 | −24.786 | −0.045 | −0.041 | −0.097 |
| 4th Coefficient A | 6.404E−03 | −1.457E−02 | 5.711E−02 | 5.829E−02 | 6.089E−01 | −2.952E−01 | 1.015E−01 |
| 6th Coefficient B | 9.502E−03 | 5.493E−02 | −2.047E−01 | 4.922E−01 | −5.199E+00 | 4.693E+00 | 1.199E+00 |
| 8th Coefficient C | −1.312E−02 | −6.803E−02 | 8.356E−01 | −4.576E+00 | 2.807E+01 | −3.012E+01 | −1.046E+01 |
| 10th Coefficient D | 1.293E−02 | 8.174E−02 | −2.581E+00 | 2.387E+01 | −9.818E+01 | 1.202E+02 | 4.473E+01 |
| 12th Coefficient E | −8.676E−03 | −8.227E−02 | 6.047E+00 | −8.126E+01 | 2.190E+02 | −3.292E+02 | −1.243E+02 |
| 14th Coefficient F | 4.056E−03 | 6.323E−02 | −1.030E+01 | 1.914E+02 | −2.824E+02 | 6.413E+02 | 2.404E+02 |
| 16th Coefficient G | −1.356E−03 | −3.600E−02 | 1.265E+01 | −3.203E+02 | 1.073E+02 | −9.011E+02 | −3.312E+02 |
| 18th Coefficient H | 3.292E−04 | 1.503E−02 | −1.121E+01 | 3.852E+02 | 2.821E+02 | 9.140E+02 | 3.266E+02 |
| 20th Coefficient J | −5.817E−05 | −4.563E−03 | 7.169E+00 | −3.330E+02 | −5.463E+02 | −6.618E+02 | −2.283E+02 |
| 22nd Coefficient L | 7.401E−06 | 9.909E−04 | −3.268E+00 | 2.046E+02 | 4.514E+02 | 3.331E+02 | 1.103E+02 |
| 24th Coefficient M | −6.601E−07 | −1.495E−04 | 1.036E+00 | −8.692E+01 | −1.889E+02 | −1.106E+02 | −3.497E+01 |
| 26th Coefficient N | 3.913E−08 | 1.486E−05 | −2.168E−01 | 2.420E+01 | 3.256E+01 | 2.175E+01 | 6.541E+00 |
| 28th Coefficient O | −1.384E−09 | −8.716E−07 | 2.695E−02 | −3.958E+00 | 0.000E+00 | −1.918E+00 | −5.468E−01 |
| 30th Coefficient P | 2.206E−11 | 2.284E−08 | −1.507E−03 | 2.871E−01 | 0.000E+00 | 0.000E+00 | 0.000E+00 |

| | S9 | S10 | S11 | S12 | S13 | S14 | S15 |
|---|---|---|---|---|---|---|---|
| Conic Constant K | −0.075 | −0.104 | 0.010 | 0.239 | 0.200 | −0.391 | −0.168 |
| 4th Coefficient A | −7.414E−02 | 5.506E−01 | 7.518E−02 | −3.712E−01 | −4.004E−01 | 2.260E−01 | 1.324E−01 |
| 6th Coefficient B | 7.358E−01 | −1.519E+00 | −3.945E−01 | 1.422E−01 | 3.217E−01 | −8.548E−02 | −6.939E−02 |
| 8th Coefficient C | −2.824E+00 | 2.681E+00 | 6.872E−01 | 1.608E−01 | −1.393E−01 | 2.103E−02 | 2.534E−02 |
| 10th Coefficient D | 6.734E+00 | −3.225E+00 | −6.627E−01 | −2.589E−01 | 2.525E−02 | −2.812E−03 | −6.631E−03 |
| 12th Coefficient E | −1.098E+01 | 2.752E+00 | 4.070E−01 | 1.796E−01 | 5.936E−03 | −5.753E−05 | 1.268E−03 |
| 14th Coefficient F | 1.269E+01 | −1.703E+00 | −1.675E−01 | −7.788E−02 | −5.265E−03 | 1.131E−04 | −1.793E−04 |
| 16th Coefficient G | −1.050E+01 | 7.720E−01 | 4.711E−02 | 2.307E−02 | 1.699E−03 | −2.604E−05 | 1.885E−05 |
| 18th Coefficient H | 6.200E+00 | −2.561E−01 | −9.045E−03 | −4.802E−03 | −3.346E−04 | 3.441E−06 | −1.468E−06 |
| 20th Coefficient J | −2.568E+00 | 6.144E−02 | 1.155E−03 | 7.033E−04 | 4.382E−05 | −2.981E−07 | 8.347E−08 |
| 22nd Coefficient L | 7.178E−01 | −1.037E−02 | −9.138E−05 | −7.100E−05 | −3.850E−06 | 1.724E−08 | −3.366E−09 |
| 24th Coefficient M | −1.258E−01 | 1.167E−03 | 3.674E−06 | 4.702E−06 | 2.190E−07 | −6.440E−10 | 9.118E−11 |
| 26th Coefficient N | 1.191E−02 | −7.850E−05 | −1.364E−08 | −1.838E−07 | −7.304E−09 | 1.409E−11 | −1.487E−12 |
| 28th Coefficient O | −4.146E−04 | 2.387E−06 | −2.903E−09 | 3.211E−09 | 1.087E−10 | −1.375E−13 | 1.103E−14 |
| 30th Coefficient P | 0.000E+00 | 0.000E+00 | 0.000E+00 | 0.000E+00 | 0.000E+00 | 0.000E+00 | 0.000E+00 |

### 3rd Embodiment

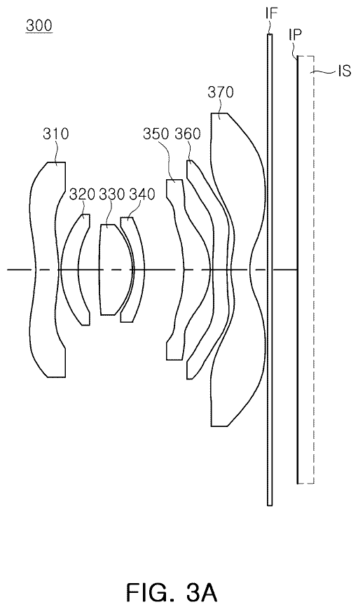

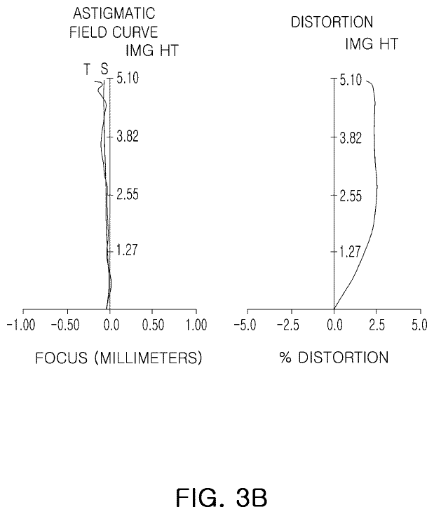

FIG. 3A is a configuration diagram of an optical imaging system according to a third embodiment of the present disclosure, and FIG. 3B is a graph illustrating aberration characteristics of the optical imaging system according to FIG. 3A.

An optical imaging system 300 according to the third embodiment of the present disclosure may include a first lens 310, a second lens 320, a third lens 330, a fourth lens 340, a fifth lens 350, a sixth lens 360, and a seventh lens 370 disposed in order from an object side. Additionally, an image sensor IS having a filter IF and an imaging plane IP may be sequentially disposed on an image side of the seventh lens 370. A stop (not shown) for controlling the amount of light may be disposed between the second lens 320 and the third lens 330.

Physical and optical characteristics of optical elements configuring the optical imaging system 300 according to the third embodiment of the present disclosure are as illustrated in Table 5 below.

TABLE 5

| Surface | | Radius of | Thickness/ | Refractive | | Effective radius |
|---|---|---|---|---|---|---|
| No. | Component | Curvature | Distance | Index | Abbe No. | (Clear Aperture) |
| S1 | 1st Lens | −3.377 | 0.663 | 1.546 | 56.00 | 2.883 |
| S2 | | −3.007 | 0.030 | | | 2.204 |
| S3 | 2nd Lens | 2.656 | 0.483 | 1.619 | 25.90 | 1.469 |
| S4 | | 2.522 | 0.609 | | | 1.185 |
| S5 | STOP | Infinity | 0.008 | | | 0.895 |
| S6 | 3rd Lens | 20.945 | 0.941 | 1.546 | 56.00 | 0.924 |
| S7 | | −2.297 | 0.030 | | | 1.221 |
| S8 | 4th Lens | −3.096 | 0.280 | 1.688 | 18.20 | 1.267 |
| S9 | | −5.171 | 1.107 | | | 1.423 |
| S10 | 5th Lens | −3.774 | 0.757 | 1.546 | 56.00 | 2.046 |
| S11 | | −1.470 | 0.030 | | | 2.395 |
| S12 | 6th Lens | 41.000 | 0.404 | 1.677 | 19.20 | 2.552 |
| S13 | | 8.067 | 0.119 | | | 2.923 |
| S14 | 7th Lens | 1.634 | 0.517 | 1.546 | 56.00 | 3.670 |
| S15 | | 0.915 | 0.500 | | | 4.145 |
| S16 | Filter | Infinity | 0.110 | 1.518 | 64.17 | |
| S17 | | Infinity | 0.749 | | | |
| S18 | Imaging | Infinity | | | | |
| | Plane | | | | | |

In the third embodiment of the present disclosure, the first lens 310 may have positive refractive power, a first surface of the first lens 310 may have a concave shape, and a second surface of the first lens 310 may have a convex shape. The second lens 320 may have positive refractive power, a first surface of the second lens 320 may have a convex shape, and a second surface of the second lens 320 may have a concave shape. The third lens 330 may have positive refractive power, and both a first surface and a second surface of the third lens 330 may have a convex shape. The fourth lens 340 may have negative refractive power, a first surface of the fourth lens 340 may have a concave shape, and a second surface of the fourth lens 340 may have a convex shape. The fifth lens 350 may have positive refractive power, a first surface of the fifth lens 350 may have a concave shape, and a second surface of the fifth lens 350 may have a convex shape. The sixth lens 360 may have negative refractive power, a first surface of the sixth lens 360 may have a convex shape, and a second surface of the sixth lens 360 may have a concave shape. The seventh lens 370 may have negative refractive power, a first surface of the seventh lens 370 may have a convex shape, and a second surface of the seventh lens 370 may have a concave shape.

The optical imaging system 300 according to the third embodiment of the present disclosure may include three or more high refractive lenses. A high refractive lens may refer to a lens having a refractive index of 1.6 or higher, and the second lens 320, the fourth lens 340, and the sixth lens 360 may correspond to high refractive lenses, and a refractive index of the fourth lens 340 may be the maximum.

Aspherical data of individual lenses configuring optical imaging system 300 according to the third embodiment of the present disclosure are as illustrated in Table 6 below. According to the third embodiment, both the first and second surfaces of the first lens 310 to the seventh lens 370 may be aspherical.

TABLE 6

| | S1 | S2 | S3 | S4 | S6 | S7 | S8 |
|---|---|---|---|---|---|---|---|
| Conic Constant K | −15.102 | −32.134 | −1.696 | −21.665 | −0.062 | −0.066 | −0.140 |
| 4th Coefficient A | 8.911E−03 | −8.982E−03 | 4.830E−02 | 3.998E−02 | 1.050E+00 | −3.296E−02 | 5.660E−01 |
| 6th Coefficient B | 5.319E−03 | 4.369E−02 | −1.718E−01 | 8.371E−01 | −1.104E+01 | 2.805E+00 | −2.432E+00 |
| 8th Coefficient C | −9.766E−03 | −6.440E−02 | 8.190E−01 | −7.500E+00 | 7.403E+01 | −2.041E+01 | 8.681E+00 |
| 10th Coefficient D | 1.114E−02 | 9.797E−02 | −2.959E+00 | 3.965E+01 | −3.323E+02 | 8.600E+01 | −2.378E+01 |
| 12th Coefficient E | −8.090E−03 | −1.169E−01 | 7.882E+00 | −1.389E+02 | 1.029E+03 | −2.465E+02 | 4.598E+01 |
| 14th Coefficient F | 3.989E−03 | 1.004E−01 | −1.491E+01 | 3.389E+02 | −2.236E+03 | 5.024E+02 | −5.959E+01 |
| 16th Coefficient G | −1.391E−03 | −6.169E−02 | 2.006E+01 | −5.895E+02 | 3.421E+03 | −7.385E+02 | 4.788E+01 |
| 18th Coefficient H | 3.501E−04 | 2.721E−02 | −1.938E+01 | 7.388E+02 | −3.651E+03 | 7.825E+02 | −1.781E+01 |
| 20th Coefficient J | −6.386E−05 | −8.610E−03 | 1.346E+01 | −6.671E+02 | 2.647E+03 | −5.905E+02 | −5.530E+00 |
| 22nd Coefficient L | 8.363E−06 | 1.933E−03 | −6.659E+00 | 4.291E+02 | −1.236E+03 | 3.089E+02 | 1.027E+01 |
| 24th Coefficient M | −7.656E−07 | −2.998E−04 | 2.289E+00 | −1.912E+02 | 3.329E+02 | −1.063E+02 | −5.377E+00 |
| 26th Coefficient N | 4.649E−08 | 3.048E−05 | −5.193E−01 | 5.596E+01 | −3.899E+01 | 2.161E+01 | 1.358E+00 |
| 28th Coefficient O | −1.681E−09 | −1.825E−06 | 6.986E−02 | −9.645E+00 | 0.000E+00 | −1.964E+00 | −1.399E−01 |
| 30th Coefficient P | 2.738E−11 | 4.871E−08 | −4.216E−03 | 7.396E−01 | 0.000E+00 | 0.000E+00 | 0.000E+00 |

| | S9 | S10 | S11 | S12 | S13 | S14 | S15 |
|---|---|---|---|---|---|---|---|
| Conic Constant K | −0.078 | −0.108 | 0.010 | 0.239 | 0.200 | −0.391 | −0.168 |
| 4th Coefficient A | −5.709E−02 | 5.528E−01 | 7.518E−02 | −3.712E−01 | −4.004E−01 | 2.260E−01 | 1.324E−01 |
| 6th Coefficient B | 6.214E−01 | −1.462E+00 | −3.945E−01 | 1.422E−01 | 3.217E−01 | −8.548E−02 | −6.939E−02 |
| 8th Coefficient C | −2.314E+00 | 2.483E+00 | 6.872E−01 | 1.608E−01 | −1.393E−01 | 2.103E−02 | 2.534E−02 |
| 10th Coefficient D | 5.244E+00 | −2.880E+00 | −6.627E−01 | −2.589E−01 | 2.525E−02 | −2.812E−03 | −6.631E−03 |
| 12th Coefficient E | −8.076E+00 | 2.372E+00 | 4.070E−01 | 1.796E−01 | 5.936E−03 | −5.753E−05 | 1.268E−03 |
| 14th Coefficient F | 8.787E+00 | −1.417E+00 | −1.675E−01 | −7.788E−02 | −5.265E−03 | 1.131E−04 | −1.793E−04 |
| 16th Coefficient G | −6.843E+00 | 6.206E−01 | 4.711E−02 | 2.307E−02 | 1.699E−03 | −2.604E−05 | 1.885E−05 |
| 18th Coefficient H | 3.798E+00 | −1.990E−01 | −9.045E−03 | −4.802E−03 | −3.346E−04 | 3.441E−06 | −1.468E−06 |
| 20th Coefficient J | −1.470E+00 | 4.617E−02 | 1.155E−03 | 7.033E−04 | 4.382E−05 | −2.981E−07 | 8.347E−08 |
| 22nd Coefficient L | 3.779E−01 | −7.539E−03 | −9.138E−05 | −7.100E−05 | −3.850E−06 | 1.724E−08 | −3.366E−09 |
| 24th Coefficient M | −5.873E−02 | 8.211E−04 | 3.674E−06 | 4.702E−06 | 2.190E−07 | −6.440E−10 | 9.118E−11 |
| 26th Coefficient N | 4.424E−03 | −5.349E−05 | −1.364E−08 | −1.838E−07 | −7.304E−09 | 1.409E−11 | −1.487E−12 |
| 28th Coefficient O | −6.388E−05 | 1.576E−06 | −2.903E−09 | 3.211E−09 | 1.087E−10 | −1.375E−13 | 1.103E−14 |
| 30th Coefficient P | 0.000E+00 | 0.000E+00 | 0.000E+00 | 0.000E+00 | 0.000E+00 | 0.000E+00 | 0.000E+00 |

### 4th Embodiment

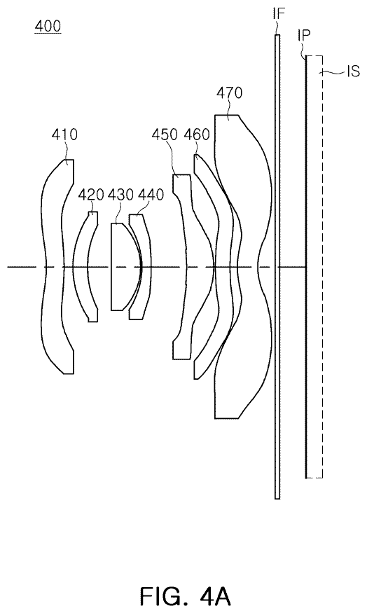

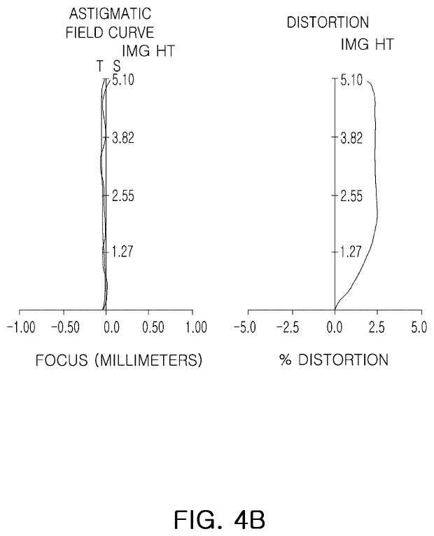

FIG. 4A is a configuration diagram of an optical imaging system according to a fourth embodiment of the present disclosure, and FIG. 4B is a graph illustrating aberration characteristics of the optical imaging system according to FIG. 4A.

An optical imaging system 400 according to the fourth embodiment of the present disclosure may include a first lens 410, a second lens 420, a third lens 430, a fourth lens 440, a fifth lens 450, a sixth lens 460, and a seventh lens 470 disposed in order from an object side. Additionally, an image sensor IS having a filter IF and an imaging plane IP may be sequentially disposed on an image side of the seventh lens 470. A stop (not shown) for controlling the amount of light may be disposed between the second lens 420 and the third lens 430.

Physical and optical characteristics of optical elements configuring the optical imaging system 400 according to the fourth embodiment of the present disclosure are as illustrated in Table 7 below.

TABLE 7

| Surface | | Radius of | Thickness/ | Refractive | | Effective radius |
|---|---|---|---|---|---|---|
| No. | Component | Curvature | Distance | Index | Abbe No. | (Clear Aperture) |
| S1 | 1st Lens | −3.079 | 0.520 | 1.546 | 56.00 | 2.878 |
| S2 | | −3.052 | 0.220 | | | 2.348 |
| S3 | 2nd Lens | 3.238 | 0.445 | 1.619 | 25.90 | 1.481 |
| S4 | | 3.608 | 0.630 | | | 1.228 |
| S5 | STOP | Infinity | 0.013 | | | 0.904 |
| S6 | 3rd Lens | 26.070 | 0.837 | 1.546 | 56.00 | 0.936 |
| S7 | | −2.324 | 0.040 | | | 1.197 |
| S8 | 4th Lens | −3.408 | 0.280 | 1.677 | 19.20 | 1.249 |
| S9 | | −7.282 | 1.022 | | | 1.416 |
| S10 | 5th Lens | −5.366 | 0.760 | 1.571 | 37.40 | 2.113 |
| S11 | | −1.798 | 0.031 | | | 2.498 |
| S12 | 6th Lens | 10.818 | 0.404 | 1.677 | 56.00 | 2.692 |
| S13 | | 5.287 | 0.224 | | | 3.022 |
| S14 | 7th Lens | 1.547 | 0.557 | 1.537 | 55.70 | 3.640 |
| S15 | | 0.959 | 0.530 | | | 4.087 |
| S16 | Filter | Infinity | 0.110 | 1.518 | 64.17 | |
| S17 | | Infinity | 0.738 | | | |
| S18 | Imaging | Infinity | | | | |
| | Plane | | | | | |

In the fourth embodiment of the present disclosure, the first lens 410 may have positive refractive power, a first surface of the first lens 410 may have a concave shape, and a second surface of the first lens 410 may have a convex shape. The second lens 420 may have positive refractive power, a first surface of the second lens 420 may have a convex shape, and a second surface of the second lens 420 may have a concave shape. The third lens 430 may have positive refractive power, and both a first surface and a second surface of the third lens 430 may have a convex shape. The fourth lens 440 may have negative refractive power, a first surface of the fourth lens 440 may have a concave shape, and a second surface of the fourth lens 440 may have a convex shape. The fifth lens 450 may have positive refractive power, a first surface of the fifth lens 450 may have a concave shape, and a second surface of the fifth lens 450 may have a convex shape. The sixth lens 460 may have negative refractive power, a first surface of the sixth lens 460 may have a convex shape, and a second surface of the sixth lens 460 may have a concave shape. The seventh lens 470 may have negative refractive power, a first surface of the seventh lens 470 may have a convex shape, and a second surface of the seventh lens 470 may have a concave shape.

The optical imaging system 400 according to the fourth embodiment of the present disclosure may include three or more high refractive lenses. A high refractive lens may refer to a lens having a refractive index of 1.6 or higher, and the second lens 420, the fourth lens 440, and the sixth lens 460 may correspond to high refractive lenses, and a refractive index of the fourth lens 440 may be the maximum. Also, in the fourth embodiment of the present disclosure, the refractive index of the sixth lens 460 may be the same as that of the fourth lens 440.

Aspherical data of individual lenses configuring optical imaging system 400 according to the fourth embodiment of the present disclosure are as illustrated in Table 8 below. According to the fourth embodiment, both the first and second surfaces of the first lens 410 to the seventh lens 470 may be aspherical.

TABLE 8

| | S1 | S2 | S3 | S4 | S6 | S7 | S8 |
|---|---|---|---|---|---|---|---|
| Conic Constant K | −18.130 | −31.104 | −3.775 | −33.808 | −0.040 | −0.016 | −0.055 |
| 4th Coefficient A | 3.479E−03 | 7.438E−03 | 8.916E−02 | 6.190E−02 | 5.648E−01 | 2.935E−02 | 2.586E−01 |
| 6th Coefficient B | 2.192E−02 | 4.108E−02 | −2.418E−01 | 2.497E−01 | −4.435E+00 | −8.479E−03 | −2.255E+00 |
| 8th Coefficient C | −2.603E−02 | −7.016E−02 | 7.955E−01 | −2.075E+00 | 2.090E+01 | −1.651E+00 | 1.269E+01 |
| 10th Coefficient D | 2.078E−02 | 8.546E−02 | −1.867E+00 | 9.330E+00 | −6.191E+01 | 1.112E+01 | −4.967E+01 |
| 12th Coefficient E | −1.173E−02 | −7.466E−02 | 3.073E+00 | −2.751E+01 | 1.176E+02 | −4.249E+01 | 1.370E+02 |
| 14th Coefficient F | 4.776E−03 | 4.742E−02 | −3.465E+00 | 5.714E+01 | −1.485E+02 | 1.097E+02 | −2.690E+02 |
| 16th Coefficient G | −1.421E−03 | −2.211E−02 | 2.585E+00 | −8.596E+01 | 1.465E+02 | −1.990E+02 | 3.791E+02 |
| 18th Coefficient H | 3.100E−04 | 7.587E−03 | −1.137E+00 | 9.433E+01 | −1.634E+02 | 2.550E+02 | −3.838E+02 |
| 20th Coefficient J | −4.946E−05 | −1.909E−03 | 1.281E−01 | −7.504E+01 | 1.990E+02 | −2.286E+02 | 2.763E+02 |
| 22nd Coefficient L | 5.683E−06 | 3.472E−04 | 1.729E−01 | 4.248E+01 | −1.731E+02 | 1.400E+02 | −1.379E+02 |
| 24th Coefficient M | −4.567E−07 | −4.442E−05 | −1.196E−01 | −1.653E+01 | 8.303E+01 | −5.573E+01 | 4.527E+01 |
| 26th Coefficient N | 2.428E−08 | 3.788E−06 | 3.737E−02 | 4.156E+00 | −1.638E+01 | 1.297E+01 | −8.779E+00 |
| 28th Coefficient O | −7.642E−10 | −1.934E−07 | −6.052E−03 | −5.979E−01 | 0.000E+00 | −1.338E+00 | 7.610E−01 |
| 30th Coefficient P | 1.074E−11 | 4.467E−09 | 4.096E−04 | 3.643E−02 | 0.000E+00 | 0.000E+00 | 0.000E+00 |

| | S9 | S10 | S11 | S12 | S13 | S14 | S15 |
|---|---|---|---|---|---|---|---|
| Conic Constant K | −0.064 | −0.093 | 0.098 | 0.292 | 0.194 | −0.293 | −0.178 |
| 4th Coefficient A | −6.821E−02 | 4.809E−01 | −2.539E−01 | −6.021E−01 | −4.144E−01 | 6.652E−02 | 1.152E−01 |
| 6th Coefficient B | 5.192E−01 | −1.258E+00 | 2.377E−01 | 5.957E−01 | 3.741E−01 | 5.032E−02 | −4.964E−02 |
| 8th Coefficient C | −1.923E+00 | 2.100E+00 | −6.255E−02 | −3.742E−01 | −2.090E−01 | −5.333E−02 | 1.491E−02 |
| 10th Coefficient D | 4.515E+00 | −2.388E+00 | −7.285E−02 | 1.579E−01 | 7.793E−02 | 2.517E−02 | −3.185E−03 |
| 12th Coefficient E | −7.160E+00 | 1.923E+00 | 8.861E−02 | −4.492E−02 | −1.974E−02 | −7.490E−03 | 4.885E−04 |
| 14th Coefficient F | 7.860E+00 | −1.118E+00 | −4.801E−02 | 8.086E−03 | 3.296E−03 | 1.528E−03 | −5.374E−05 |
| 16th Coefficient G | −6.004E+00 | 4.734E−01 | 1.598E−02 | −6.652E−04 | −3.102E−04 | −2.206E−04 | 4.164E−06 |
| 18th Coefficient H | 3.148E+00 | −1.458E−01 | −3.530E−03 | −6.840E−05 | 1.168E−06 | 2.278E−05 | −2.162E−07 |
| 20th Coefficient J | −1.087E+00 | 3.229E−02 | 5.283E−04 | 2.849E−05 | 4.078E−06 | −1.672E−06 | 6.497E−09 |
| 22nd Coefficient L | 2.236E−01 | −5.000E−03 | −5.294E−05 | −4.044E−06 | −5.919E−07 | 8.530E−08 | −4.104E−11 |
| 24th Coefficient M | −1.950E−02 | 5.133E−04 | 3.391E−06 | 3.161E−07 | 4.280E−08 | −2.874E−09 | −4.538E−12 |
| 26th Coefficient N | −1.150E−03 | −3.134E−05 | −1.247E−07 | −1.349E−08 | −1.648E−09 | 5.756E−11 | 1.604E−13 |
| 28th Coefficient O | 2.675E−04 | 8.607E−07 | 1.981E−09 | 2.463E−10 | 2.692E−11 | −5.190E−13 | −1.786E−15 |
| 30th Coefficient P | 0.000E+00 | 0.000E+00 | 0.000E+00 | 0.000E+00 | 0.000E+00 | 0.000E+00 | 0.000E+00 |

### 5th Embodiment

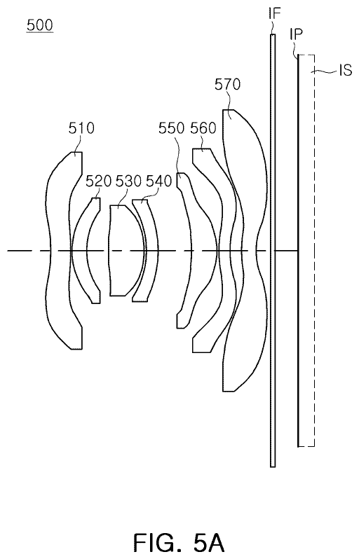

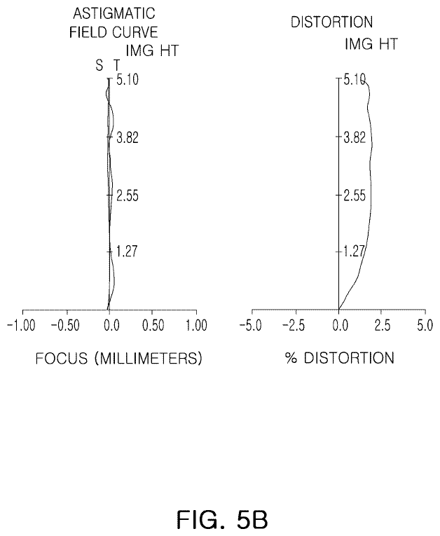

FIG. 5A is a configuration diagram of an optical imaging system according to a fifth embodiment of the present disclosure, and FIG. B is a graph illustrating aberration characteristics of the optical imaging system according to FIG. 5A.

An optical imaging system 500 according to the fifth embodiment of the present disclosure may include a first lens 510, a second lens 520, a third lens 530, a fourth lens 540, a fifth lens 550, a sixth lens 560, and a seventh lens 570 disposed in order from an object side. Additionally, an image sensor IS having a filter IF and an imaging plane IP may be sequentially disposed on an image side of the seventh lens 570. A stop (not shown) for controlling the amount of light may be disposed between the second lens 520 and the third lens 530.

Physical and optical characteristics of optical elements configuring the optical imaging system 500 according to the fifth embodiment of the present disclosure are as illustrated in Table 9 below.

TABLE 9

| Surface | | Radius of | Thickness/ | Refractive | | Effective radius |
|---|---|---|---|---|---|---|
| No. | Component | Curvature | Distance | Index | Abbe No. | (Clear Aperture) |
| S1 | 1st Lens | −3.147 | 0.617 | 1.546 | 56.00 | 2.889 |
| S2 | | −2.969 | 0.030 | | | 2.287 |
| S3 | 2nd Lens | 2.912 | 0.444 | 1.619 | 25.90 | 1.565 |
| S4 | | 2.621 | 0.627 | | | 1.250 |
| S5 | STOP | Infinity | 0.052 | | | 0.952 |
| S6 | 3rd Lens | 12.287 | 1.086 | 1.546 | 56.00 | 1.062 |
| S7 | | −2.418 | 0.048 | | | 1.339 |
| S8 | 4th Lens | −3.072 | 0.320 | 1.695 | 18.40 | 1.440 |
| S9 | | −4.752 | 1.056 | | | 1.502 |
| S10 | 5th Lens | −5.348 | 0.787 | 1.546 | 56.00 | 2.010 |
| S11 | | −1.563 | 0.030 | | | 2.284 |
| S12 | 6th Lens | 5.181 | 0.350 | 1.677 | 19.20 | 2.534 |
| S13 | | 2.860 | 0.338 | | | 2.979 |
| S14 | 7th Lens | 1.7289 | 0.411 | 1.546 | 56.00 | 3.660 |
| S15 | | 0.986 | 0.500 | | | 4.098 |
| S16 | Filter | Infinity | 0.110 | 1.518 | 64.17 | |
| S17 | | Infinity | 0.717 | | | |
| S18 | Imaging | Infinity | | | | |
| | Plane | | | | | |

In the fifth embodiment of the present disclosure, the first lens 510 may have positive refractive power, a first surface of the first lens 510 may have a concave shape, and a second surface of the first lens 510 may have a convex shape. The second lens 520 may have negative refractive power, a first surface of the second lens 520 may have a convex shape, and a second surface of the second lens 520 may have a concave shape. The third lens 530 may have positive refractive power, and both a first surface and a second surface of the third lens 530 may have a convex shape. The fourth lens 540 may have negative refractive power, a first surface of the fourth lens 540 may have a concave shape, and a second surface of the fourth lens 540 may have a convex shape. The fifth lens 550 may have positive refractive power, a first surface of the fifth lens 550 may have a concave shape, and a second surface of the fifth lens 550 may have a convex shape. The sixth lens 560 may have negative refractive power, a first surface of the sixth lens 560 may have a convex shape, and a second surface of the sixth lens 560 may have a concave shape. The seventh lens 570 may have negative refractive power, a first surface of the seventh lens 570 may have a convex shape, and a second surface of the seventh lens 570 may have a concave shape.

The optical imaging system 500 according to the fifth embodiment of the present disclosure may include three or more high refractive lenses. A high refractive lens may refer to a lens having a refractive index of 1.6 or higher, and the second lens 520, the fourth lens 540, and the sixth lens 560 may correspond to high refractive lenses, and a refractive index of the fourth lens 540 may be the maximum.

Aspherical data of individual lenses configuring optical imaging system 500 according to the fifth embodiment of the present disclosure are as illustrated in Table 10 below. According to the fifth embodiment, both the first and second surfaces of the first lens 510 to the seventh lens 570 may be aspherical.

TABLE 10

| | S1 | S2 | S3 | S4 | S6 | S7 | S8 |
|---|---|---|---|---|---|---|---|
| Conic Constant K | −22.326 | −39.865 | −0.318 | −18.946 | −0.010 | −0.053 | −0.090 |
| 4th Coefficient A | −2.970E−03 | 2.511E−03 | 2.681E−02 | 3.774E−02 | 1.869E−01 | −6.757E−02 | 2.163E−02 |
| 6th Coefficient B | 3.673E−02 | 5.420E−02 | −8.700E−03 | 2.505E−01 | −2.444E+00 | 1.841E+00 | 9.127E−01 |
| 8th Coefficient C | −4.526E−02 | −8.797E−02 | −3.221E−01 | −1.756E+00 | 1.998E+01 | −1.096E+01 | −4.838E+00 |
| 10th Coefficient D | 3.749E−02 | 1.123E−01 | 1.684E+00 | 8.745E+00 | −1.040E+02 | 3.932E+01 | 1.406E+01 |
| 12th Coefficient E | −2.191E−02 | −1.081E−01 | −4.436E+00 | −2.994E+01 | 3.583E+02 | −9.575E+01 | −2.706E+01 |
| 14th Coefficient F | 9.238E−03 | 7.715E−02 | 7.608E+00 | 7.213E+01 | −8.427E+02 | 1.643E+02 | 3.633E+01 |
| 16th Coefficient G | −2.850E−03 | −4.062E−02 | −9.129E+00 | −1.239E+02 | 1.373E+03 | −2.015E+02 | −3.456E+01 |
| 18th Coefficient H | 6.474E−04 | 1.572E−02 | 7.868E+00 | 1.528E+02 | −1.548E+03 | 1.773E+02 | 2.327E+01 |
| 20th Coefficient J | −1.080E−04 | −4.442E−03 | −4.896E+00 | −1.348E+02 | 1.184E+03 | −1.108E+02 | −1.090E+01 |
| 22nd Coefficient L | 1.305E−05 | 9.025E−04 | 2.178E+00 | 8.404E+01 | −5.865E+02 | 4.800E+01 | 3.436E+00 |
| 24th Coefficient M | −1.111E−06 | −1.281E−04 | −6.735E−01 | −3.591E+01 | 1.694E+02 | −1.369E+01 | −6.837E−01 |
| 26th Coefficient N | 6.320E−08 | 1.203E−05 | 1.372E−01 | 9.935E+00 | −2.164E+01 | 2.310E+00 | 7.566E−02 |
| 28th Coefficient O | −2.154E−09 | −6.707E−07 | −1.651E−02 | −1.587E+00 | 0.000E+00 | −1.746E−01 | −3.385E−03 |
| 30th Coefficient P | 3.325E−11 | 1.678E−08 | 8.871E−04 | 1.095E−01 | 0.000E+00 | 0.000E+00 | 0.000E+00 |

| | S9 | S10 | S11 | S12 | S13 | S14 | S15 |
|---|---|---|---|---|---|---|---|
| Conic Constant K | −0.114 | −0.065 | 0.095 | 0.165 | 0.147 | −1.000 | −3.071 |
| 4th Coefficient A | 1.783E−01 | 2.849E−01 | −2.417E−01 | −3.289E−01 | −2.964E−01 | −2.844E−01 | −1.840E−01 |
| 6th Coefficient B | −5.978E−01 | −6.940E−01 | 4.036E−01 | 2.884E−01 | 2.557E−01 | 7.387E−02 | 1.093E−01 |
| 8th Coefficient C | 2.218E+00 | 1.142E+00 | −5.294E−01 | −1.704E−01 | −1.418E−01 | 1.678E−02 | −4.330E−02 |
| 10th Coefficient D | −6.071E+00 | −1.341E+00 | 5.268E−01 | 7.491E−02 | 5.464E−02 | −2.014E−02 | 1.258E−02 |
| 12th Coefficient E | 1.149E+01 | 1.154E+00 | −3.828E−01 | −2.658E−02 | −1.512E−02 | 7.921E−03 | −2.763E−03 |
| 14th Coefficient F | −1.524E+01 | −7.380E−01 | 2.009E−01 | 7.993E−03 | 3.034E−03 | −1.893E−03 | 4.636E−04 |
| 16th Coefficient G | 1.438E+01 | 3.519E−01 | −7.592E−02 | −2.013E−03 | −4.391E−04 | 3.079E−04 | −5.946E−05 |
| 18th Coefficient H | −9.701E+00 | −1.244E−01 | 2.058E−02 | 4.034E−04 | 4.462E−05 | −3.542E−05 | 5.803E−06 |
| 20th Coefficient J | 4.640E+00 | 3.209E−02 | −3.959E−03 | −6.073E−05 | −2.995E−06 | 2.912E−06 | −4.259E−07 |
| 22nd Coefficient L | −1.535E+00 | −5.858E−03 | 5.270E−04 | 6.500E−06 | 1.129E−07 | −1.697E−07 | 2.305E−08 |
| 24th Coefficient M | 3.339E−01 | 7.157E−04 | −4.617E−05 | −4.627E−07 | −8.460E−10 | 6.827E−09 | −8.884E−10 |
| 26th Coefficient N | −4.287E−02 | −5.239E−05 | 2.394E−06 | 1.953E−08 | −9.918E−11 | −1.793E−10 | 2.300E−11 |
| 28th Coefficient O | 2.459E−03 | 1.735E−06 | −5.568E−08 | −3.690E−10 | 2.801E−12 | 2.743E−12 | −3.575E−13 |
| 30th Coefficient P | 0.000E+00 | 0.000E+00 | 0.000E+00 | 0.000E+00 | 0.000E+00 | −1.830E−14 | 2.515E−15 |

### 6th Embodiment

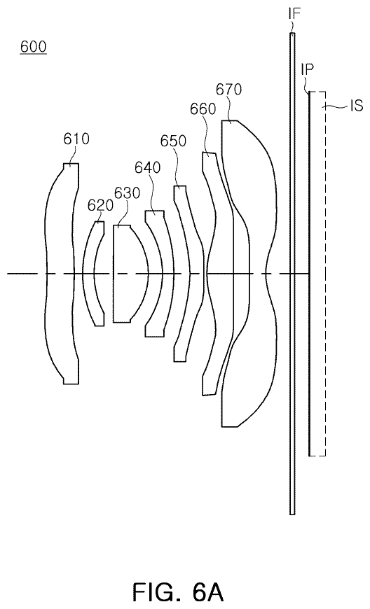

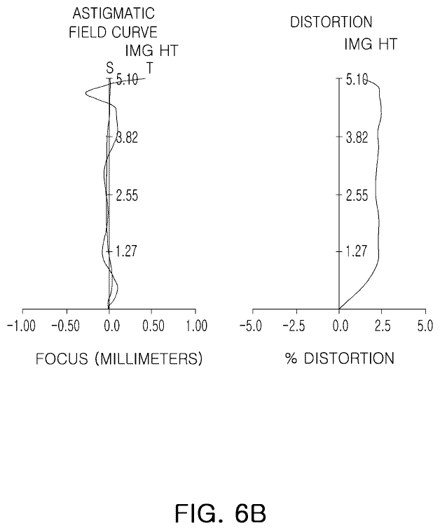

FIG. 6A is a configuration diagram of an optical imaging system according to a sixth embodiment of the present disclosure, and FIG. 6B is a graph illustrating aberration characteristics of the optical imaging system according to FIG. 6A.

An optical imaging system 600 according to the sixth embodiment of the present disclosure may include a first lens 610, a second lens 620, a third lens 630, a fourth lens 640, a fifth lens 650, a sixth lens 660, and a seventh lens 670 disposed in order from an object side. Additionally, an image sensor IS having a filter IF and an imaging plane IP may be sequentially disposed on an image side of the seventh lens 670. A stop (not shown) for controlling the amount of light may be disposed between the second lens 620 and the third lens 630.

Physical and optical characteristics of optical elements configuring the optical imaging system 600 according to the sixth embodiment of the present disclosure are as illustrated in Table 11 below.

TABLE 11

| Surface | | Radius of | Thickness/ | Refractive | | Effective radius |
|---|---|---|---|---|---|---|
| No. | Component | Curvature | Distance | Index | Abbe No. | (Clear Aperture) |
| S1 | 1st Lens | −4.381 | 0.738 | 1.546 | 56.00 | 2.880 |
| S2 | | −2.753 | 0.193 | | | 2.361 |
| S3 | 2nd Lens | 2.941 | 0.312 | 1.619 | 25.90 | 1.371 |
| S4 | | 2.174 | 0.386 | | | 1.081 |
| S5 | STOP | Infinity | 0.179 | | | 0.947 |
| S6 | 3rd Lens | 11.117 | 0.939 | 1.546 | 56.00 | 1.000 |
| S7 | | −2.512 | 0.381 | | | 1.256 |
| S8 | 4th Lens | −5.625 | 0.300 | 1.677 | 19.20 | 1.425 |
| S9 | | −31.503 | 0.473 | | | 1.635 |
| S10 | 5th Lens | −2.274 | 0.400 | 1.571 | 37.40 | 2.016 |
| S11 | | −5.135 | 0.050 | | | 2.293 |
| S12 | 6th Lens | 2.270 | 0.740 | 1.546 | 56.00 | 2.895 |
| S13 | | −3.435 | 0.400 | | | 3.201 |
| S14 | 7th Lens | 3.940 | 0.450 | 1.537 | 55.70 | 3.583 |
| S15 | | 1.142 | 0.700 | | | 4.030 |
| S16 | Filter | Infinity | 0.110 | 1.518 | 64.17 | |
| S17 | | Infinity | 0.424 | | | |
| S18 | Imaging | Infinity | | | | |
| | Plane | | | | | |

In the sixth embodiment of the present disclosure, the first lens 610 may have positive refractive power, a first surface of the first lens 610 may have a concave shape, and a second surface of the first lens 610 may have a convex shape. The second lens 620 may have negative refractive power, a first surface of the second lens 620 may have a convex shape, and a second surface of the second lens 620 may have a concave shape. The third lens 630 may have positive refractive power, and both a first surface and a second surface of the third lens 630 may have a convex shape. The fourth lens 640 may have negative refractive power, a first surface of the fourth lens 640 may have a concave shape, and a second surface of the fourth lens 640 may have a convex shape. The fifth lens 650 may have negative refractive power, a first surface of the fifth lens 650 may have a concave shape, and a second surface of the fifth lens 650 may have a convex shape. The sixth lens 660 may have positive refractive power, and both a first surface and a second surface of the sixth lens 660 may have a convex shape. The seventh lens 670 may have negative refractive power, a first surface of the seventh lens 670 may have a convex shape, and a second surface of the seventh lens 670 may have a concave shape.

The optical imaging system 600 according to the sixth embodiment of the present disclosure may include two or more high refractive lenses. A high refractive lens may refer to a lens having a refractive index of 1.6 or higher, the second lens 620 and the fourth lens 640 may correspond to high refractive lenses, and a refractive index of the fourth lens 640 may be the maximum.

Aspherical data of individual lenses configuring optical imaging system 600 according to the sixth embodiment of the present disclosure are as illustrated in Table 12 below. According to the sixth embodiment, both the first and second surfaces of the first lens 610 to the seventh lens 670 may be aspherical.

TABLE 12

| | S1 | S2 | S3 | S4 | S6 | S7 | S8 |
|---|---|---|---|---|---|---|---|
| Conic Constant K | 0.730 | −1.777 | 0.661 | 0.872 | 0.174 | −0.095 | −0.286 |
| 4th Coefficient A | 6.256E−02 | 2.521E−01 | 2.063E−01 | −1.431E−01 | −4.097E+00 | 4.009E−01 | 1.068E+00 |
| 6th Coefficient B | −1.308E−02 | −3.797E−01 | −6.847E−01 | 3.661E+00 | 5.207E+01 | −3.598E+00 | −5.243E+00 |
| 8th Coefficient C | −1.159E−02 | 5.209E−01 | 2.297E+00 | −4.848E+01 | −4.127E+02 | 1.995E+01 | 1.703E+01 |
| 10th Coefficient D | 2.101E−02 | −5.594E−01 | −8.138E+00 | 3.784E+02 | 2.180E+03 | −7.299E+01 | −3.816E+01 |
| 12th Coefficient E | −1.739E−02 | 4.494E−01 | 2.393E+01 | −1.942E+03 | −8.011E+03 | 1.852E+02 | 6.158E+01 |
| 14th Coefficient F | 9.349E−03 | −2.669E−01 | −5.279E+01 | 6.895E+03 | 2.100E+04 | −3.361E+02 | −7.324E+01 |
| 16th Coefficient G | −3.514E−03 | 1.170E−01 | 8.500E+01 | −1.742E+04 | −3.978E+04 | 4.427E+02 | 6.487E+01 |
| 18th Coefficient H | 9.458E−04 | −3.780E−02 | −9.926E+01 | 3.179E+04 | 5.458E+04 | −4.244E+02 | −4.275E+01 |
| 20th Coefficient J | −1.834E−04 | 8.937E−03 | 8.368E+01 | −4.198E+04 | −5.370E+04 | 2.931E+02 | 2.069E+01 |
| 22nd Coefficient L | 2.538E−05 | −1.522E−03 | −5.029E+01 | 3.973E+04 | 3.691E+04 | −1.421E+02 | −7.151E+00 |
| 24th Coefficient M | −2.445E−06 | 1.812E−04 | 2.099E+01 | −2.625E+04 | −1.683E+04 | 4.584E+01 | 1.669E+00 |
| 26th Coefficient N | 1.557E−07 | −1.426E−05 | −5.774E+00 | 1.150E+04 | 4.568E+03 | −8.839E+00 | −2.355E−01 |
| 28th Coefficient O | −5.893E−09 | 6.646E−07 | 9.411E−01 | −2.999E+03 | −5.589E+02 | 7.704E−01 | 1.517E−02 |
| 30th Coefficient P | 1.003E−10 | −1.382E−08 | −6.880E−02 | 3.524E+02 | 0.000E+00 | 0.000E+00 | 0.000E+00 |

| | S9 | S10 | S11 | S12 | S13 | S14 | S15 |
|---|---|---|---|---|---|---|---|
| Conic Constant K | −0.123 | −0.077 | −0.223 | −0.010 | 0.385 | −0.037 | −0.302 |
| 4th Coefficient A | 1.614E−01 | 7.888E−01 | 2.813E−01 | −1.083E−01 | −5.165E−01 | −2.439E−01 | 1.482E−01 |
| 6th Coefficient B | −2.264E−01 | −2.178E+00 | −3.217E−01 | 1.298E−01 | 4.516E−01 | 2.934E−01 | −5.497E−02 |
| 8th Coefficient C | −2.324E−01 | 3.864E+00 | 3.017E−01 | −9.459E−02 | −2.852E−01 | −1.840E−01 | 1.605E−02 |
| 10th Coefficient D | 1.675E+00 | −4.836E+00 | −2.038E−01 | 4.658E−02 | 1.325E−01 | 7.431E−02 | −3.878E−03 |
| 12th Coefficient E | −3.482E+00 | 4.418E+00 | 1.038E−01 | −1.530E−02 | −4.574E−02 | −2.062E−02 | 7.874E−04 |
| 14th Coefficient F | 4.266E+00 | −2.988E+00 | −4.203E−02 | 3.032E−03 | 1.175E−02 | 4.064E−03 | −1.307E−04 |
| 16th Coefficient G | −3.490E+00 | 1.498E+00 | 1.359E−02 | −2.131E−04 | −2.240E−03 | −5.785E−04 | 1.697E−05 |
| 18th Coefficient H | 1.986E+00 | −5.537E−01 | −3.401E−03 | −5.833E−05 | 3.142E−04 | 5.974E−05 | −1.659E−06 |
| 20th Coefficient J | −7.913E−01 | 1.483E−01 | 6.366E−04 | 1.985E−05 | −3.186E−05 | −4.436E−06 | 1.183E−07 |
| 22nd Coefficient L | 2.171E−01 | −2.792E−02 | −8.605E−05 | −2.871E−06 | 2.268E−06 | 2.311E−07 | −5.919E−09 |
| 24th Coefficient M | −3.908E−02 | 3.494E−03 | 7.988E−06 | 2.336E−07 | −1.072E−07 | −8.017E−09 | 1.964E−10 |
| 26th Coefficient N | 4.156E−03 | −2.606E−04 | −4.594E−07 | −1.040E−08 | 3.022E−09 | 1.664E−10 | −3.867E−12 |
| 28th Coefficient O | −1.976E−04 | 8.754E−06 | 1.239E−08 | 1.980E−10 | −3.839E−11 | −1.564E−12 | 3.419E−14 |
| 30th Coefficient P | 0.000E+00 | 0.000E+00 | 0.000E+00 | 0.000E+00 | 0.000E+00 | 0.000E+00 | 0.000E+00 |

### 7th Embodiment

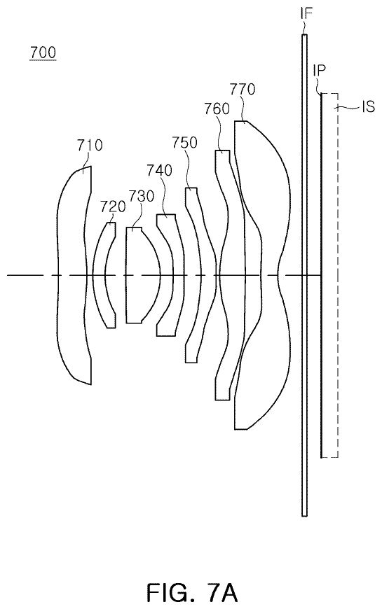

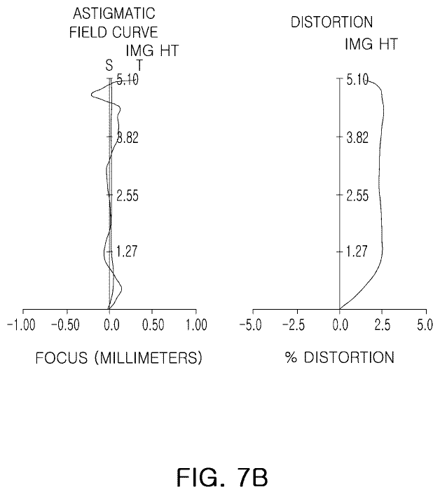

FIG. 7A is a configuration diagram of an optical imaging system according to a seventh embodiment of the present disclosure, and FIG. 7B is a graph illustrating aberration characteristics of the optical imaging system according to FIG. 7A.

An optical imaging system 700 according to the seventh embodiment of the present disclosure may include a first lens 710, a second lens 720, a third lens 730, a fourth lens 740, a fifth lens 750, a sixth lens 760, and a seventh lens 770 disposed in order from an object side. Additionally, an image sensor IS having a filter IF and an imaging plane IP may be sequentially disposed on an image side of the seventh lens 770. A stop (not shown) for controlling the amount of light may be disposed between the second lens 720 and the third lens 730.

Physical and optical characteristics of optical elements configuring the optical imaging system 700 according to the seventh embodiment of the present disclosure are as illustrated in Table 13 below.

TABLE 13

| Surface | | Radius of | Thickness/ | Refractive | | Effective radius |
|---|---|---|---|---|---|---|
| No. | Component | Curvature | Distance | Index | Abbe No. | (Clear Aperture) |
| S1 | 1st Lens | −4.389 | 0.762 | 1.546 | 56.00 | 2.873 |
| S2 | | −2.805 | 0.189 | | | 2.325 |
| S3 | 2nd Lens | 2.930 | 0.310 | 1.619 | 25.90 | 1.373 |
| S4 | | 2.188 | 0.387 | | | 1.087 |
| S5 | STOP | Infinity | 0.180 | | | 0.952 |
| S6 | 3rd Lens | 10.771 | 0.950 | 1.546 | 56.00 | 1.030 |
| S7 | | −2.504 | 0.366 | | | 1.273 |
| S8 | 4th Lens | −5.986 | 0.300 | 1.677 | 19.20 | 1.439 |
| S9 | | −46.676 | 0.486 | | | 1.633 |
| S10 | 5th Lens | −2.259 | 0.400 | 1.571 | 37.40 | 1.992 |
| S11 | | −4.987 | 0.050 | | | 2.314 |
| S12 | 6th Lens | 2.332 | 0.740 | 1.546 | 56.00 | 2.972 |
| S13 | | −3.454 | 0.400 | | | 3.251 |
| S14 | 7th Lens | 3.749 | 0.450 | 1.537 | 55.70 | 3.573 |
| S15 | | 1.136 | 0.700 | | | 4.029 |
| S16 | Filter | Infinity | 0.110 | 1.518 | 64.17 | |
| S17 | | Infinity | 0.433 | | | |
| S18 | Imaging | Infinity | | | | |
| | Plane | | | | | |

In the seventh embodiment of the present disclosure, the first lens 710 may have positive refractive power, a first surface of the first lens 710 may have a concave shape, and a second surface of the first lens 710 may have a convex shape. The second lens 720 may have negative refractive power, a first surface of the second lens 720 may have a convex shape, and a second surface of the second lens 720 may have a concave shape. The third lens 730 may have positive refractive power, and both a first surface and a second surface of the third lens 730 may have a convex shape. The fourth lens 740 may have negative refractive power, a first surface of the fourth lens 740 may have a concave shape, and a second surface of the fourth lens 740 may have a convex shape. The fifth lens 750 may have negative refractive power, a first surface of the fifth lens 750 may have a concave shape, and a second surface of the fifth lens 750 may have a convex shape. The sixth lens 760 may have positive refractive power, and both a first surface and a second surface of the sixth lens 760 may have a convex shape. The seventh lens 770 may have negative refractive power, a first surface of the seventh lens 770 may have a convex shape, and a second surface of the seventh lens 770 may have a concave shape.

The optical imaging system 700 according to the seventh embodiment of the present disclosure may include two or more high refractive lenses. A high refractive lens may refer to a lens having a refractive index of 1.6 or higher, the second lens 720 and the fourth lens 740 may correspond to high refractive lenses, and a refractive index of the fourth lens 740 may be the maximum.

Aspherical data of individual lenses configuring optical imaging system 700 according to the seventh embodiment of the present disclosure are as illustrated in Table 14 below. According to the seventh embodiment, both the first and second surfaces of the first lens 710 to the seventh lens 770 may be aspherical.

TABLE 14

| | S1 | S2 | S3 | S4 | S6 | S7 | S8 |
|---|---|---|---|---|---|---|---|
| Conic Constant K | 0.718 | −1.824 | 0.576 | 0.825 | 0.165 | −0.095 | −0.277 |
| 4th Coefficient A | 6.199E−02 | 2.564E−01 | 2.065E−01 | −1.482E−01 | −3.812E+00 | 3.707E−01 | 9.628E−01 |
| 6th Coefficient B | −1.213E−02 | −3.945E−01 | −6.642E−01 | 3.706E+00 | 4.792E+01 | −3.272E+00 | −4.766E+00 |
| 8th Coefficient C | −1.217E−02 | 5.570E−01 | 2.113E+00 | −4.832E+01 | −3.768E+02 | 1.801E+01 | 1.564E+01 |
| 10th Coefficient D | 2.092E−02 | −6.174E−01 | −7.236E+00 | 3.724E+02 | 1.978E+03 | −6.549E+01 | −3.516E+01 |
| 12th Coefficient E | −1.692E−02 | 5.128E−01 | 2.101E+01 | −1.887E+03 | −7.223E+03 | 1.654E+02 | 5.660E+01 |
| 14th Coefficient F | 8.953E−03 | −3.153E−01 | −4.616E+01 | 6.620E+03 | 1.883E+04 | −2.991E+02 | −6.677E+01 |
| 16th Coefficient G | −3.323E−03 | 1.433E−01 | 7.413E+01 | −1.653E+04 | −3.547E+04 | 3.930E+02 | 5.838E+01 |
| 18th Coefficient H | 8.859E−04 | −4.807E−02 | −8.633E+01 | 2.979E+04 | 4.839E+04 | −3.760E+02 | −3.785E+01 |
| 20th Coefficient J | −1.704E−04 | 1.182E−02 | 7.251E+01 | −3.885E+04 | −4.733E+04 | 2.592E+02 | 1.799E+01 |
| 22nd Coefficient L | 2.345E−05 | −2.098E−03 | −4.340E+01 | 3.631E+04 | 3.234E+04 | −1.254E+02 | −6.104E+00 |
| 24th Coefficient M | −2.250E−06 | 2.611E−04 | 1.802E+01 | −2.370E+04 | −1.465E+04 | 4.039E+01 | 1.401E+00 |
| 26th Coefficient N | 1.428E−07 | −2.155E−05 | −4.934E+00 | 1.025E+04 | 3.952E+03 | −7.772E+00 | −1.950E−01 |
| 28th Coefficient O | −5.389E−09 | 1.057E−06 | 8.003E−01 | −2.640E+03 | −4.803E+02 | 6.759E−01 | 1.244E−02 |
| 30th Coefficient P | 9.150E−11 | −2.328E−08 | −5.823E−02 | 3.063E+02 | 0.000E+00 | 0.000E+00 | 0.000E+00 |

| | S9 | S10 | S11 | S12 | S13 | S14 | S15 |
|---|---|---|---|---|---|---|---|
| Conic Constant K | −0.113 | −0.060 | −0.202 | 0.001 | 0.367 | −0.046 | −0.300 |
| 4th Coefficient A | 6.404E−02 | 7.062E−01 | 2.263E−01 | −1.416E−01 | −4.798E−01 | −2.232E−01 | 1.456E−01 |
| 6th Coefficient B | 1.402E−01 | −1.994E+00 | −2.813E−01 | 1.739E−01 | 3.972E−01 | 2.643E−01 | −5.285E−02 |
| 8th Coefficient C | −1.154E+00 | 3.563E+00 | 3.299E−01 | −1.332E−01 | −2.334E−01 | −1.590E−01 | 1.511E−02 |
| 10th Coefficient D | 3.399E+00 | −4.432E+00 | −2.859E−01 | 7.353E−02 | 1.013E−01 | 6.097E−02 | −3.610E−03 |
| 12th Coefficient E | −5.927E+00 | 3.994E+00 | 1.851E−01 | −3.026E−02 | −3.311E−02 | −1.602E−02 | 7.292E−04 |
| 14th Coefficient F | 6.883E+00 | −2.658E+00 | −9.099E−02 | 9.273E−03 | 8.183E−03 | 2.987E−03 | −1.200E−04 |
| 16th Coefficient G | −5.582E+00 | 1.312E+00 | 3.345E−02 | −2.096E−03 | −1.519E−03 | −4.025E−04 | 1.534E−05 |
| 18th Coefficient H | 3.217E+00 | −4.783E−01 | −8.995E−03 | 3.454E−04 | 2.086E−04 | 3.939E−05 | −1.467E−06 |
| 20th Coefficient J | −1.314E+00 | 1.268E−01 | 1.727E−03 | −4.078E−05 | −2.078E−05 | −2.777E−06 | 1.018E−07 |
| 22nd Coefficient L | 3.726E−01 | −2.369E−02 | −2.297E−04 | 3.345E−06 | 1.452E−06 | 1.375E−07 | −4.954E−09 |
| 24th Coefficient M | −6.970E−02 | 2.951E−03 | 2.007E−05 | −1.807E−07 | −6.737E−08 | −4.544E−09 | 1.597E−10 |
| 26th Coefficient N | 7.735E−03 | −2.197E−04 | −1.038E−06 | 5.764E−09 | 1.859E−09 | 8.997E−11 | −3.060E−12 |
| 28th Coefficient O | −3.854E−04 | 7.382E−06 | 2.410E−08 | −8.216E−11 | −2.308E−11 | −8.076E−13 | 2.634E−14 |
| 30th Coefficient P | 0.000E+00 | 0.000E+00 | 0.000E+00 | 0.000E+00 | 0.000E+00 | 0.000E+00 | 0.000E+00 |

### 8th Embodiment

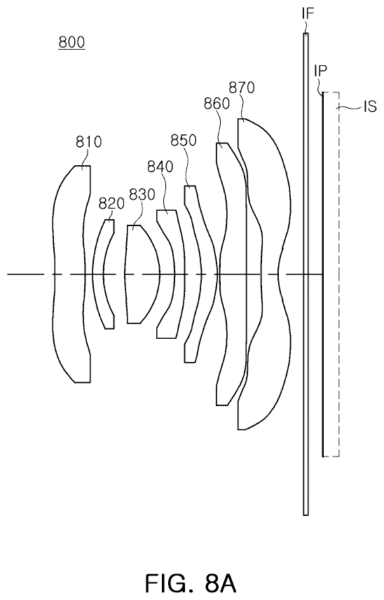

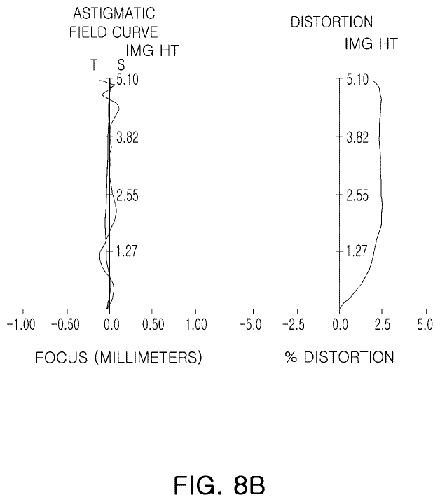

FIG. 8A is a configuration diagram of an optical imaging system according to an eighth embodiment of the present disclosure, and FIG. 8B is a graph illustrating aberration characteristics of the optical imaging system according to FIG. 8A.

An optical imaging system 800 according to the eighth embodiment of the present disclosure may include a first lens 810, a second lens 820, a third lens 830, a fourth lens 840, a fifth lens 850, a sixth lens 860, and a seventh lens 870 disposed in order from an object side. Additionally, an image sensor IS having a filter IF and an imaging plane IP may be sequentially disposed on an image side of the seventh lens 870. A stop (not shown) for controlling the amount of light may be disposed between the second lens 820 and the third lens 830.

Physical and optical characteristics of optical elements configuring the optical imaging system 800 according to the eighth embodiment of the present disclosure are as illustrated in Table 15 below.

TABLE 15

| Surface | | Radius of | Thickness/ | Refractive | | Effective radius |
|---|---|---|---|---|---|---|
| No. | Component | Curvature | Distance | Index | Abbe No. | (Clear Aperture) |
| S1 | 1st Lens | −4.400 | 0.819 | 1.546 | 56.00 | 2.841 |
| S2 | | −3.013 | 0.190 | | | 2.217 |
| S3 | 2nd Lens | 3.008 | 0.300 | 1.619 | 25.90 | 1.412 |
| S4 | | 2.261 | 0.426 | | | 1.122 |
| S5 | STOP | Infinity | 0.174 | | | 0.973 |
| S6 | 3rd Lens | 8.348 | 0.947 | 1.546 | 56.00 | 1.048 |
| S7 | | −2.505 | 0.412 | | | 1.285 |
| S8 | 4th Lens | −6.097 | 0.293 | 1.677 | 19.20 | 1.463 |
| S9 | | −257.437 | 0.457 | | | 1.677 |
| S10 | 5th Lens | −2.190 | 0.420 | 1.571 | 37.40 | 1.973 |
| S11 | | −4.042 | 0.050 | | | 2.303 |
| S12 | 6th Lens | 2.486 | 0.740 | 1.546 | 56.00 | 3.107 |
| S13 | | −4.199 | 0.400 | | | 3.414 |
| S14 | 7th Lens | 2.808 | 0.450 | 1.537 | 55.70 | 3.570 |
| S15 | | 1.081 | 0.700 | | | 4.031 |
| S16 | Filter | Infinity | 0.110 | 1.518 | 64.17 | |
| S17 | | Infinity | 0.459 | | | |
| S18 | Imaging | Infinity | | | | |
| | Plane | | | | | |

In the eighth embodiment of the present disclosure, the first lens 810 may have positive refractive power, a first surface of the first lens 810 may have a concave shape, and a second surface of the first lens 810 may have a convex shape. The second lens 820 may have negative refractive power, a first surface of the second lens 820 may have a convex shape, and a second surface of the second lens 820 may have a concave shape. The third lens 830 may have positive refractive power, and both a first surface and a second surface of the third lens 830 may have a convex shape. The fourth lens 840 may have negative refractive power, a first surface of the fourth lens 840 may have a concave shape, and a second surface of the fourth lens 840 may have a convex shape. The fifth lens 850 may have negative refractive power, a first surface of the fifth lens 850 may have a concave shape, and a second surface of the fifth lens 850 may have a convex shape. The sixth lens 860 may have positive refractive power, and both a first surface and a second surface of the sixth lens 860 may have a convex shape. The seventh lens 870 may have negative refractive power, a first surface of the seventh lens 870 may have a convex shape, and a second surface of the seventh lens 870 may have a concave shape.

The optical imaging system 800 according to the eighth embodiment of the present disclosure may include two or more high refractive lenses. A high refractive lens may refer to a lens having a refractive index of 1.6 or higher, and the second lens 820 and the fourth lens 840 may correspond to high refractive lenses, and a refractive index of the fourth lens 840 may be the maximum.

Aspherical data of individual lenses configuring optical imaging system 800 according to the eighth embodiment of the present disclosure are as illustrated in Table 16 below. According to the eighth embodiment, both the first and second surfaces of the first lens 810 to the seventh lens 870 may be aspherical.

TABLE 16

| | S1 | S2 | S3 | S4 | S6 | S7 | S8 |
|---|---|---|---|---|---|---|---|
| Conic Constant K | 0.730 | −1.948 | 0.214 | 0.666 | −0.004 | −0.113 | −0.223 |
| 4th Coefficient A | 6.539E−02 | 2.568E−01 | 1.993E−01 | −1.515E−01 | −1.032E−03 | 6.215E−01 | 5.537E−01 |
| 6th Coefficient B | −2.302E−02 | −3.952E−01 | −5.293E−01 | 3.448E+00 | 2.792E−01 | −4.791E+00 | −2.878E+00 |
| 8th Coefficient C | 8.247E−03 | 5.707E−01 | 8.177E−01 | −4.136E+01 | −3.192E+00 | 2.384E+01 | 9.915E+00 |
| 10th Coefficient D | −2.224E−03 | −6.520E−01 | −1.029E−01 | 2.953E+02 | 1.999E+01 | −7.957E+01 | −2.283E+01 |
| 12th Coefficient E | 4.195E−04 | 5.590E−01 | −3.952E+00 | −1.394E+03 | −8.452E+01 | 1.844E+02 | 3.676E+01 |
| 14th Coefficient F | −5.137E−05 | −3.547E−01 | 1.258E+01 | 4.571E+03 | 2.557E+02 | −3.034E+02 | −4.248E+01 |
| 16th Coefficient G | 4.142E−06 | 1.660E−01 | −2.217E+01 | −1.069E+04 | −5.639E+02 | 3.591E+02 | 3.572E+01 |
| 18th Coefficient H | −5.040E−07 | −5.708E−02 | 2.583E+01 | 1.810E+04 | 9.045E+02 | −3.061E+02 | −2.190E+01 |
| 20th Coefficient J | 1.449E−07 | 1.431E−02 | −2.088E+01 | −2.221E+04 | −1.039E+03 | 1.862E+02 | 9.691E+00 |
| 22nd Coefficient L | −3.227E−08 | −2.567E−03 | 1.180E+01 | 1.956E+04 | 8.289E+02 | −7.875E+01 | −3.014E+00 |
| 24th Coefficient M | 4.574E−09 | 3.190E−04 | −4.585E+00 | −1.204E+04 | −4.345E+02 | 2.199E+01 | 6.247E−01 |
| 26th Coefficient N | −4.054E−10 | −2.583E−05 | 1.167E+00 | 4.920E+03 | 1.343E+02 | −3.641E+00 | −7.733E−02 |
| 28th Coefficient O | 2.045E−11 | 1.212E−06 | −1.752E−01 | −1.198E+03 | −1.849E+01 | 2.708E−01 | 4.318E−03 |
| 30th Coefficient P | −4.447E−13 | −2.448E−08 | 1.175E−02 | 1.315E+02 | 0.000E+00 | 0.000E+00 | 0.000E+00 |
| | S9 | S10 | S11 | S12 | S13 | S14 | S15 |
| Conic Constant K | −0.093 | −0.009 | −0.138 | 0.011 | 0.284 | −1.722 | −1.009 |
| 4th Coefficient A | −1.618E−02 | 5.459E−01 | 1.629E−02 | −1.914E−01 | −3.412E−01 | −1.261E−01 | −3.477E−01 |
| 6th Coefficient B | 1.657E−01 | −1.931E+00 | 5.204E−03 | 2.562E−01 | 2.731E−01 | −1.163E−01 | 2.113E−01 |
| 8th Coefficient C | −5.154E−01 | 4.030E+00 | 9.292E−02 | −2.008E−01 | −1.586E−01 | 2.306E−01 | −9.841E−02 |
| 10th Coefficient D | 1.208E+00 | −5.530E+00 | −1.187E−01 | 1.062E−01 | 6.685E−02 | −1.876E−01 | 3.399E−02 |
| 12th Coefficient E | −2.059E+00 | 5.267E+00 | 5.717E−02 | −3.967E−02 | −2.034E−02 | 9.225E−02 | −8.812E−03 |
| 14th Coefficient F | 2.497E+00 | −3.587E+00 | −2.199E−03 | 1.067E−02 | 4.479E−03 | −3.001E−02 | 1.741E−03 |
| 16th Coefficient G | −2.154E+00 | 1.770E+00 | −1.181E−02 | −2.082E−03 | −7.163E−04 | 6.758E−03 | −2.634E−04 |
| 18th Coefficient H | 1.324E+00 | −6.328E−01 | 6.936E−03 | 2.939E−04 | 8.299E−05 | −1.080E−03 | 3.036E−05 |
| 20th Coefficient J | −5.762E−01 | 1.618E−01 | −2.099E−03 | −2.964E−05 | −6.883E−06 | 1.235E−04 | −2.628E−06 |
| 22nd Coefficient L | 1.734E−01 | −2.872E−02 | 3.877E−04 | 2.081E−06 | 3.978E−07 | −1.005E−05 | 1.669E−07 |
| 24th Coefficient M | −3.433E−02 | 3.349E−03 | −4.416E−05 | −9.641E−08 | −1.521E−08 | 5.687E−07 | −7.507E−09 |
| 26th Coefficient N | 4.020E−03 | −2.295E−04 | 2.863E−06 | 2.649E−09 | 3.452E−10 | −2.126E−08 | 2.255E−10 |
| 28th Coefficient O | −2.108E−04 | 6.973E−06 | −8.123E−08 | −3.267E−11 | −3.521E−12 | 4.723E−10 | −4.044E−12 |
| 30th Coefficient P | 0.000E+00 | 0.000E+00 | 0.000E+00 | 0.000E+00 | 0.000E+00 | −4.719E−12 | 3.269E−14 |

Table 17 illustrates other physical and optical parameters, including focal lengths, of individual lenses configuring the optical imaging system according to embodiments of the present disclosure, and Table 18 illustrates conditional data according to embodiments of the present disclosure.

TABLE 17

| | 1st | 2nd | 3rd | 4th | 5th | 6th | 7th | 8th |
|---|---|---|---|---|---|---|---|---|
| | Embodiment | Embodiment | Embodiment | Embodiment | Embodiment | Embodiment | Embodiment | Embodiment |
| f | 3.876 | 3.791 | 3.795 | 3.795 | 3.795 | 3.795 | 3.795 | 3.795 |
| f1 | 68.902 | 33.077 | 30.737 | 81.390 | 43.247 | 11.690 | 12.156 | 14.476 |
| f2 | 36.753 | 163.692 | 212.166 | 34.903 | −101.619 | −15.945 | −16.573 | −17.361 |
| f3 | 3.946 | 3.844 | 3.844 | 3.947 | 3.797 | 3.844 | 3.815 | 3.639 |
| f4 | −9.925 | −11.846 | −11.850 | −9.580 | −13.561 | −10.135 | −10.146 | −9.203 |
| f5 | 4.313 | 3.973 | 3.947 | 4.602 | 3.765 | −7.532 | −7.643 | −9.126 |
| f6 | −16.070 | −15.339 | −14.867 | −15.697 | −10.019 | 2.622 | 2.669 | 2.974 |
| f7 | −6.122 | −5.276 | −5.103 | −6.933 | −5.218 | −3.171 | −3.229 | −3.603 |
| FOV | 104.160 | 104.100 | 104.070 | 104.110 | 104.454 | 104.150 | 104.180 | 104.095 |
| IMG HT | 5.00 | 5.00 | 5.00 | 5.00 | 5.00 | 5.00 | 5.00 | 5.00 |
| TTL | 7.358 | 7.343 | 7.339 | 7.361 | 7.522 | 7.174 | 7.214 | 7.347 |
| BFL | 1.390 | 1.417 | 1.359 | 1.378 | 1.327 | 1.234 | 1.243 | 1.269 |
| Fno | 2.050 | 2.050 | 2.050 | 2.060 | 2.000 | 2.002 | 2.002 | 2.002 |
| SD1 | 2.879 | 2.880 | 2.883 | 2.878 | 2.889 | 2.880 | 2.873 | 2.841 |
| SD5 | 0.938 | 0.929 | 0.924 | 0.936 | 1.062 | 1.000 | 1.030 | 1.048 |
| SD6 | 1.195 | 1.219 | 1.221 | 1.197 | 1.339 | 1.256 | 1.273 | 1.285 |
| SD14 | 4.080 | 4.090 | 4.145 | 4.087 | 4.098 | 4.030 | 4.029 | 4.031 |

TABLE 18

| | 1st | 2nd | 3rd | 4th |
|---|---|---|---|---|
| Conditional Expression | Embodiment | Embodiment | Embodiment | Embodiment |
| TTL/(2 × IMG HT) | 0.736 | 0.734 | 0.734 | 0.736 |
| {TTL/(2 × IMG HT)} × Fno | 1.508 | 1.505 | 1.505 | 1.516 |
| 2 × f × tan(FOV/2)/(2 × IMG HT) | 0.972 | 0.972 | 0.973 | 0.973 |
| 100 × {TTL/(2 × IMG HT)}/FOV | 0.706 | 0.705 | 0.705 | 0.707 |
| SD1/SD5 | 3.070 | 3.102 | 3.121 | 3.074 |
| SD6/SD14 | 0.293 | 0.298 | 0.294 | 0.293 |
| FOV/f | 27.513 | 27.459 | 27.422 | 27.433 |
| V1-V2 | 30.10 | 30.10 | 30.10 | 30.10 |
| V1-V5 | 0.00 | 0.00 | 0.00 | 18.60 |
| V1-V7 | 0.00 | 0.00 | 0.00 | 0.30 |
| | 5th | 6th | 7th | 8th |
| Conditional Expression | Embodiment | Embodiment | Embodiment | Embodiment |
| TTL/(2 × IMG HT) | 0.752 | 0.717 | 0.721 | 0.735 |
| {TTL/(2 × IMG HT)} × Fno | 1.504 | 1.436 | 1.444 | 1.471 |
| 2 × f × tan(FOV/2)/(2 × IMG HT) | 0.979 | 0.974 | 0.975 | 0.973 |
| 100 × {TTL/(2 × IMG HT)}/FOV | 0.720 | 0.689 | 0.692 | 0.706 |
| SD1/SD5 | 2.721 | 2.880 | 0.790 | 2.711 |
| SD6/SD14 | 0.327 | 0.312 | 0.316 | 0.319 |
| FOV/f | 27.523 | 27.443 | 27.451 | 27.429 |
| V1-V2 | 30.10 | 30.10 | 30.10 | 30.10 |
| V1-V5 | 0.00 | 18.60 | 18.60 | 18.60 |
| V1-V7 | 0.00 | 0.30 | 0.30 | 0.30 |

According to one or more embodiments of the present disclosure as described herein, an ultra-wide-angle optical system may achieve high resolution and low F-value while achieving miniaturization.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system, comprising:
a first lens having positive refractive power;
a second lens having refractive power;
a third lens having positive refractive power;
a fourth lens having negative refractive power;
a fifth lens having refractive power;
a sixth lens having a convex object-side surface; and
a seventh lens having negative refractive power,
wherein the first to seventh lenses are disposed in order from an object side, and
wherein the following conditional expression is satisfied:
$$2.7 < SD 1 / SD 5 < 3.3 ,$$
where SD1 is an effective radius of an object-side surface of the first lens, and SD5 is an effective radius of an object-side surface of the third lens.

2. The optical imaging system of claim 1, wherein the first lens has a concave object-side surface.

3. The optical imaging system of claim 1, wherein the third lens has a convex object-side surface and a convex image-side surface.

4. The optical imaging system of claim 1, wherein both the second lens and the fifth lens have positive refractive power or both have negative refractive power.

5. The optical imaging system of claim 1, wherein the sixth lens has negative refractive power.

6. The optical imaging system of claim 1, wherein the sixth lens has a concave image-side surface.

7. The optical imaging system of claim 1, wherein the second lens and the sixth lens each have negative refractive power.

8. The optical imaging system of claim 1, wherein the sixth lens has positive refractive power and a convex image-side surface.

9. The optical imaging system of claim 1, wherein the following conditional expressions are satisfied:
$$10 < V 1 - V 2 < 50 , and$$
$$- 10 < V 1 - V 5 < 30 ,$$
where V1 is an Abbe number of the first lens, V2 is an Abbe number of the second lens, and V5 is an Abbe number of the fifth lens.

10. The optical imaging system of claim 1, wherein the following conditional expression is satisfied:
$$25 < FOV / f < 30 ( unit : degree ( ° ) / mm ) ,$$
where FOV is a field of view of the optical imaging system, and f is a total focal length of the optical imaging system.

11. The optical imaging system of claim 1, wherein the following conditional expression is satisfied:
$$1.4 < \{ TTL / ( 2 \times IMG HT ) \} \times F n o < 1.6 ,$$
where TTL is a distance on an optical axis from an object-side surface of the first lens to an imaging plane, IMG HT is half a diagonal length of the image plane, and Fno (F-number) is a value representing brightness of the optical imaging system.

12. The optical imaging system of claim 1, wherein the following conditional expression is satisfied:
$$0.27 < SD 6 / SD 14 < 0.35 ,$$
where SD6 is an effective radius of an image-side surface of the third lens, and SD14 is an effective radius of an image-side surface of the seventh lens.

13. An optical imaging system comprising:
a first lens having positive refractive power;
a second lens having refractive power;
a third lens having a convex object-side surface and a convex image-side surface;
a fourth lens having negative refractive power;
a fifth lens having refractive power;
a sixth lens having a convex object-side surface; and
a seventh lens having negative refractive power,
wherein the first to seventh lenses are disposed in order from an object side.

14. The optical imaging system of claim 13, wherein the following conditional expressions are satisfied:
$$10 < V 1 - V 2 < 50 , and$$
$$- 10 < V 1 - V 7 < 10 ,$$
where V1 is an Abbe number of the first lens, V2 is an Abbe number of the second lens, and V7 is an Abbe number of the seventh lens.

15. The optical imaging system of claim 13, wherein the following conditional expression is satisfied:
$$0.95 < 2 \times f \times tan ( FOV / 2 ) / ( 2 \times IMG HT ) < 1.05 ,$$
where f is a total focal length of the optical imaging system, FOV is a field of view of the optical imaging system, and IMG HT is half a diagonal length of an imaging plane.

16. The optical imaging system of claim 13, wherein the following conditional expression is satisfied:
$$2.7 < SD 1 / SD 5 < 3.3 ,$$
where SD1 is an effective radius of an object-side surface of the first lens, and SD5 is an effective radius of an object-side surface of the third lens.
